(19) United States
(12) Patent Application Publication
(10) Pub. No.: US 2025/0293794 A1
(43) Pub. Date: Sep. 18, 2025

(54) BIT ALLOCATIONS FOR MULTI-LEVEL CODING IN WIRELESS COMMUNICATIONS

(71) Applicant: QUALCOMM Incorporated, San Diego, CA (US)

(72) Inventors: Wei YANG, San Diego, CA (US); Jing JIANG, San Diego, CA (US); Liangming WU, Beijing (CN); Gabi SARKIS, San Diego, CA (US)

(21) Appl. No.: 18/863,304

(22) PCT Filed: Jul. 4, 2022
(86) PCT No.: PCT/CN2022/103579

§ 371 Date: Nov. 5, 2024

(51) Int. Cl. H04L 1/00; H04W 72/044

(52) U.S. Cl. CPC H04L 1/0003; H04W 72/046

(57) ABSTRACT

Methods, systems, and devices for wireless communications are described. In some examples, a device may compute the coding rate associated with each coding level of coded modulation scheme based on one or more channel conditions of a wireless channel. The device may allocate multiple information bits among multiple coding schemes associated with a multi-level coding scheme. The quantity of information bits allocated to each coding scheme may be based on the coding rates associated with one or more coding levels corresponding to the coding scheme. The device may encode an information payload using the multiple coding schemes in accordance with the allocation of the multiple information bits. The device may transmit the encoded information payload via the wireless channel. The receiving device may compute the coding rate associated with each coding level of the multi-level coding scheme and allocate the information bits accordingly. The receiving device may decode the payload.

### CROSS REFERENCE

The present application is a 371 national stage filing of International PCT Application No. PCT/CN2022/103579 by YANG et al. entitled “BIT ALLOCATIONS FOR MULTI-LEVEL CODING IN WIRELESS COMMUNICATIONS,” filed Jul. 4, 2022, which is assigned to the assignee hereof, and which is expressly incorporated by reference in its entirety herein.

### FIELD OF TECHNOLOGY

The following relates to wireless communications, including bit allocations for multi-level coding (MLC) in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, an encoding device may encode an information payload for transmission to a decoding device. In some examples, such devices may support multiple coding schemes. Techniques for encoding and decoding an information payload using multiple coding schemes may be desired.

### SUMMARY

The described techniques relate to improved methods, systems, devices, and apparatuses that support bit allocations for multi-level coding (MLC) in wireless communications. For example, the described techniques provide for an encoding device and a decoding device to independently determine information bit allocations among different coding schemes of an MLC scheme based on instantaneous channel conditions. For instance, the encoding device and decoding device may compute a coding rate associated with each coding level of a coded modulation scheme based on one or more channel conditions of a wireless channel. The encoding device and decoding device may allocate a set of information bits among the coding schemes of the MLC scheme based on coding levels to which the coding schemes correspond. For example, each coding scheme may correspond to one or more coding levels, and the encoding device and decoding device may allocate (e.g., proportionally) information bits among the coding schemes based on the coding rates of the corresponding coding levels. The encoding device may encode an information payload using the multiple coding schemes according to the allocation of the set of information bits and transmit the encoded information payload to the decoding device. The decoding device may decode the encoded information payload according to the allocation of the set of information bits.

A method for wireless communication is described. The method may include computing a coding rate associated with each coding level of a coded modulation scheme based on one or more channel conditions of a wireless channel, allocating a set of multiple information bits among a set of multiple coding schemes associated with an MLC scheme, where a quantity of information bits allocated to each coding scheme is based on the coding rates associated with one or more coding levels corresponding to the coding scheme, encoding an information payload using the set of multiple coding schemes in accordance with the allocation of the set of multiple information bits, and transmitting the encoded information payload via the wireless channel.

An apparatus for wireless communication is described. The apparatus may include a processor, memory coupled with the processor, and instructions stored in the memory. The instructions may be executable by the processor to cause the apparatus to compute a coding rate associated with each coding level of a coded modulation scheme based on one or more channel conditions of a wireless channel, allocate a set of multiple information bits among a set of multiple coding schemes associated with an MLC scheme, where a quantity of information bits allocated to each coding scheme is based on the coding rates associated with one or more coding levels corresponding to the coding scheme, encode an information payload using the set of multiple coding schemes in accordance with the allocation of the set of multiple information bits, and transmit the encoded information payload via the wireless channel.

Another apparatus for wireless communication is described. The apparatus may include means for computing a coding rate associated with each coding level of a coded modulation scheme based on one or more channel conditions of a wireless channel, means for allocating a set of multiple information bits among a set of multiple coding schemes associated with an MLC scheme, where a quantity of information bits allocated to each coding scheme is based on the coding rates associated with one or more coding levels corresponding to the coding scheme, means for encoding an information payload using the set of multiple coding schemes in accordance with the allocation of the set of multiple information bits, and means for transmitting the encoded information payload via the wireless channel.

A non-transitory computer-readable medium storing code for wireless communication is described. The code may include instructions executable by a processor to compute a coding rate associated with each coding level of a coded modulation scheme based on one or more channel conditions of a wireless channel, allocate a set of multiple information bits among a set of multiple coding schemes associated with an MLC scheme, where a quantity of information bits allocated to each coding scheme is based on the coding rates associated with one or more coding levels corresponding to the coding scheme, encode an information payload using the set of multiple coding schemes in accordance with the allocation of the set of multiple information bits, and transmit the encoded information payload via the wireless channel.

In some examples of the method, apparatuses, and non-transitory computer-readable medium described herein, computing the coding rate for each coding level may include operations, features, means, or instructions for computing a set of coding rates associated with a set of modulation bits of the coded modulation scheme, each coding level of the coded modulation scheme corresponding to one or more modulation bits of the coded modulation scheme, where the coding rate associated with each coding level may be a coding rate associated with the one or more modulation bits of each respective coding level.

In some examples of the method, apparatuses, and non-transitory computer-readable medium described herein, computing the set of coding rates may include operations, features, means, or instructions for computing a coding rate associated with a modulation bit of the coded modulation scheme based on bit values of modulation bits corresponding to less significant bits than the modulation bit.

In some examples of the method, apparatuses, and non-transitory computer-readable medium described herein, computing the set of coding rates may include operations, features, means, or instructions for computing a coding rate associated with a modulation bit of the coded modulation scheme based on excluding bit values of other modulation bits of the coded modulation scheme from the computation of the coding rate associated with the modulation bit.

In some examples of the method, apparatuses, and non-transitory computer-readable medium described herein, computing the set of coding rates may include operations, features, means, or instructions for computing the set of coding rates such that a summation of the set of coding rates may be equal to a quantity of the coding levels multiplied by a coding rate associated with the wireless channel.

Some examples of the method, apparatuses, and non-transitory computer-readable medium described herein may further include operations, features, means, or instructions for polarizing the coding levels into a set of polarized coding levels, each polarized coding level associated with a respective second coding rate, where each coding scheme corresponds to one or more polarized coding levels and where the quantity of information bits allocated to each coding scheme may be based on the second coding rates associated with the one or more polarized coding levels corresponding to the coding scheme.

Some examples of the method, apparatuses, and non-transitory computer-readable medium described herein may further include operations, features, means, or instructions for polarizing a subset of the coding levels into a set of polarized coding levels, each polarized coding level associated with a respective second coding rate, where each coding scheme corresponds to one or more non-polarized coding levels, one or more polarized coding levels, or a combination thereof and where the quantity of information bits allocated to each coding scheme may be based on the coding rates corresponding to the coding scheme, the second coding rates associated with the one or more polarized coding levels corresponding to the coding scheme, or a combination thereof.

Some examples of the method, apparatuses, and non-transitory computer-readable medium described herein may further include operations, features, means, or instructions for computing a second coding rate associated with each spatial layer of a set of spatial layers based on the one or more channel conditions of the wireless channel, the set of spatial layers associated with a set of coded modulation schemes including the coded modulation scheme and where each coding scheme corresponds to one or more spatial layers of the set of spatial layers, and where the quantity of information bits allocated to each coding scheme may be based on the second coding rates associated with the one or more spatial layers corresponding to the coding scheme.

In some examples of the method, apparatuses, and non-transitory computer-readable medium described herein, the quantity of information bits allocated to each coding scheme may be proportional to the coding rates corresponding to the coding scheme.

In some examples of the method, apparatuses, and non-transitory computer-readable medium described herein, the quantity of information bits allocated to each coding scheme may be based on a ratio of a summation of the coding rates corresponding to the coding scheme to a summation of each of the coding rates.

In some examples of the method, apparatuses, and non-transitory computer-readable medium described herein, a quantity of coding schemes of the set of multiple coding schemes may be less than or equal to a quantity of coding levels of the coded modulation scheme.

Some examples of the method, apparatuses, and non-transitory computer-readable medium described herein may further include operations, features, means, or instructions for allocating a set of multiple non-information bits among the set of multiple coding schemes, where a quantity of non-information bits allocated to each coding scheme may be based on the coding rates associated with the one or more coding levels corresponding to the coding scheme, and where the information payload may be encoded in accordance with the allocation of the set of multiple non-information bits.

In some examples of the method, apparatuses, and non-transitory computer-readable medium described herein, a coding scheme of the set of multiple the coding schemes may be an unencoded coding scheme based on a coding rate corresponding to the coding scheme satisfying a threshold.

In some examples of the method, apparatuses, and non-transitory computer-readable medium described herein, the one or more channel conditions include a capacity of the wireless channel, a coding rate associated with the wireless channel, a reliability of the wireless channel or a combination thereof.

In some examples of the method, apparatuses, and non-transitory computer-readable medium described herein, the set of multiple coding schemes includes one or more low-density parity check (LDPC) codes, one or more turbo codes, one or more polar codes, one or more Reed Solomon codes, one or more staircase codes, one or more rateless codes, one or more product codes, one or more spinal codes, one or more Reed Muller codes, one or more Bose-Chaudhuri-Hocquenghem (BCH) codes, or any combination thereof.

In some examples of the method, apparatuses, and non-transitory computer-readable medium described herein, the set of multiple coding schemes includes a set of multiple polar codes.

In some examples of the method, apparatuses, and non-transitory computer-readable medium described herein, the set of multiple coding schemes includes a joint polar code including a set of multiple subpolar codes and each subpolar code corresponds to one or more coding levels of the coded modulation scheme.

A method for wireless communication is described. The method may include receiving an information payload of encoded bits via a wireless channel, computing a coding rate associated with each coding level of a coded modulation scheme based on one or more channel conditions of the wireless channel, allocating a set of multiple information bits among a set of multiple coding schemes associated with an MLC scheme, where a quantity of information bits allocated to each coding scheme is based on the coding rates associated with one or more coding levels corresponding to the coding scheme, and decoding the information payload using the set of multiple coding schemes in accordance with the allocation of the set of multiple information bits.

An apparatus for wireless communication is described. The apparatus may include a processor, memory coupled with the processor, and instructions stored in the memory. The instructions may be executable by the processor to cause the apparatus to receive an information payload of encoded bits via a wireless channel, compute a coding rate associated with each coding level of a coded modulation scheme based on one or more channel conditions of the wireless channel, allocate a set of multiple information bits among a set of multiple coding schemes associated with an MLC scheme, where a quantity of information bits allocated to each coding scheme is based on the coding rates associated with one or more coding levels corresponding to the coding scheme, and decode the information payload using the set of multiple coding schemes in accordance with the allocation of the set of multiple information bits.

Another apparatus for wireless communication is described. The apparatus may include means for receiving an information payload of encoded bits via a wireless channel, means for computing a coding rate associated with each coding level of a coded modulation scheme based on one or more channel conditions of the wireless channel, means for allocating a set of multiple information bits among a set of multiple coding schemes associated with an MLC scheme, where a quantity of information bits allocated to each coding scheme is based on the coding rates associated with one or more coding levels corresponding to the coding scheme, and means for decoding the information payload using the set of multiple coding schemes in accordance with the allocation of the set of multiple information bits.

A non-transitory computer-readable medium storing code for wireless communication is described. The code may include instructions executable by a processor to receive an information payload of encoded bits via a wireless channel, compute a coding rate associated with each coding level of a coded modulation scheme based on one or more channel conditions of the wireless channel, allocate a set of multiple information bits among a set of multiple coding schemes associated with an MLC scheme, where a quantity of information bits allocated to each coding scheme is based on the coding rates associated with one or more coding levels corresponding to the coding scheme, and decode the information payload using the set of multiple coding schemes in accordance with the allocation of the set of multiple information bits.

In some examples of the method, apparatuses, and non-transitory computer-readable medium described herein, computing the coding rate for each coding level may include operations, features, means, or instructions for computing a set of coding rates associated with a set of modulation bits of the coded modulation scheme, each coding level of the coded modulation scheme corresponding to one or more modulation bits of the coded modulation scheme, where the coding rate associated with each coding level may be a coding rate associated with the one or more modulation bits of each respective coding level.

In some examples of the method, apparatuses, and non-transitory computer-readable medium described herein, computing the set of coding rates may include operations, features, means, or instructions for computing a coding rate associated with a modulation bit of the coded modulation scheme based on bit values of modulation bits corresponding to less significant bits than the modulation bit.

In some examples of the method, apparatuses, and non-transitory computer-readable medium described herein, computing the set of coding rates may include operations, features, means, or instructions for computing a coding rate associated with a modulation bit of the coded modulation scheme based on excluding bit values of other modulation bits of the coded modulation scheme from the computation of the coding rate associated with the modulation bit.

In some examples of the method, apparatuses, and non-transitory computer-readable medium described herein, computing the set of coding rates may include operations, features, means, or instructions for computing the set of coding rates such that a summation of the set of coding rates may be equal to a quantity of the coding levels multiplied by a coding rate associated with the wireless channel.

Some examples of the method, apparatuses, and non-transitory computer-readable medium described herein may further include operations, features, means, or instructions for polarizing the coding levels into a set of polarized coding levels, each polarized coding level associated with a respective second coding rate, where each coding scheme corresponds to one or more polarized coding levels and where the quantity of information bits allocated to each coding scheme may be based on the second coding rates associated with the one or more polarized coding levels corresponding to the coding scheme.

Some examples of the method, apparatuses, and non-transitory computer-readable medium described herein may further include operations, features, means, or instructions for polarizing a subset of the coding levels into a set of polarized coding levels, each polarized coding level associated with a respective second coding rate, where each coding scheme corresponds to one or more non-polarized coding levels, one or more polarized coding levels, or a combination thereof and where the quantity of information bits allocated to each coding scheme may be based on the coding rates corresponding to the coding scheme, the second coding rates associated with the one or more polarized coding levels corresponding to the coding scheme, or a combination thereof.

Some examples of the method, apparatuses, and non-transitory computer-readable medium described herein may further include operations, features, means, or instructions for computing a second coding rate associated with each spatial layer of a set of spatial layers based on the one or more channel conditions of the wireless channel, the set of spatial layers associated with a set of coded modulation schemes including the coded modulation scheme, where each coding scheme corresponds to one or more spatial layers of the set of spatial layers, and where the quantity of information bits allocated to each coding scheme may be based on the second coding rates associated with the one or more spatial layers corresponding to the coding scheme.

In some examples of the method, apparatuses, and non-transitory computer-readable medium described herein, the quantity of information bits allocated to each coding scheme may be proportional to the coding rates corresponding to the coding scheme.

In some examples of the method, apparatuses, and non-transitory computer-readable medium described herein, the quantity of information bits allocated to each coding scheme may be based on a ratio of a summation of the coding rates corresponding to the coding scheme to a summation of each of the coding rates.

In some examples of the method, apparatuses, and non-transitory computer-readable medium described herein, a quantity of coding schemes of the set of multiple coding schemes may be less than or equal to a quantity of coding levels of the coded modulation scheme.

Some examples of the method, apparatuses, and non-transitory computer-readable medium described herein may further include operations, features, means, or instructions for allocating a set of multiple non-information bits among the set of multiple coding schemes, where a quantity of non-information bits allocated to each coding scheme may be based on the coding rates associated with the one or more coding levels corresponding to the coding scheme, and where the information payload may be decoded in accordance with the allocation of the set of multiple non-information bits.

In some examples of the method, apparatuses, and non-transitory computer-readable medium described herein, a coding scheme of the set of multiple the coding schemes may be an unencoded coding scheme based on a coding rate corresponding to the coding scheme satisfying a threshold.

In some examples of the method, apparatuses, and non-transitory computer-readable medium described herein, the one or more channel conditions include a capacity of the wireless channel, a coding rate associated with the wireless channel, a reliability of the wireless channel or a combination thereof.

In some examples of the method, apparatuses, and non-transitory computer-readable medium described herein, the set of multiple coding schemes includes one or more LDPC codes, one or more turbo codes, one or more polar codes, one or more Reed Solomon codes, one or more staircase codes, one or more rateless codes, one or more product codes, one or more spinal codes, one or more Reed Muller codes, one or more BCH codes, or any combination thereof.

In some examples of the method, apparatuses, and non-transitory computer-readable medium described herein, the set of multiple coding schemes includes a set of multiple polar codes.

In some examples of the method, apparatuses, and non-transitory computer-readable medium described herein, the set of multiple coding schemes includes a joint polar code including a set of multiple subpolar codes and each subpolar code corresponds to one or more coding levels of the coded modulation scheme.

### BRIEF DESCRIPTION OF THE DRAWINGS

FIGS. 1 and 2 illustrate examples of wireless communications systems that support bit allocations for multi-level coding (MLC) in wireless communications in accordance with one or more aspects of the present disclosure.

FIG. 3 illustrates an example of an allocation diagram that supports bit allocations for MLC in wireless communications in accordance with one or more aspects of the present disclosure.

FIG. 4 illustrates an example of a wireless communications system that supports bit allocations for MLC in wireless communications in accordance with one or more aspects of the present disclosure.

FIGS. 5 and 6 illustrate examples of allocation diagrams that support bit allocations for MLC in wireless communications in accordance with one or more aspects of the present disclosure.

FIG. 7 illustrates an example of a process flow that supports bit allocations for MLC in wireless communications in accordance with one or more aspects of the present disclosure.

FIGS. 8 and 9 show block diagrams of devices that support bit allocations for MLC in wireless communications in accordance with one or more aspects of the present disclosure.

FIG. 10 shows a block diagram of a communications manager that supports bit allocations for MLC in wireless communications in accordance with one or more aspects of the present disclosure.

FIG. 11 shows a diagram of a system including a device that supports bit allocations for MLC in wireless communications in accordance with one or more aspects of the present disclosure.

FIGS. 12 through 17 show flowcharts illustrating methods that support bit allocations for MLC in wireless communications in accordance with one or more aspects of the present disclosure.

### DETAILED DESCRIPTION

In some wireless communications systems, a transmitting device may use one or more coding schemes to encode information payloads for transmission. In some examples, it may be advantageous for the transmitting device to use a multi-level coding (MLC) scheme to encode and transmit an information payload. For example, the transmitting device may encode different bits of a multi-level modulation scheme (e.g., a 64 quadrature amplitude modulation (QAM) scheme, 256 QAM, multi-level phase shift keying schemes, among other multi-level modulation schemes) used to encode bits for inclusion in the information payload using different coding rates, different coding schemes (e.g., polar codes, low-density parity check (LDPC) codes, subpolar codes of a join polar code, among other coding schemes), or a combination thereof. Each coding scheme (e.g., and/or coding rate) may correspond to one or more coding levels of a coded modulation scheme. For example, bits of a coded modulation scheme may be associated with a respective coding rate (e.g., reliability). Bits associated with the same coding rate may correspond to a same coding level of the coded modulation scheme, while bits associated with different coding rates may corresponding to different coding levels.

Encoding bits according to an MLC scheme may reduce encoding and decoding complexity. For example, the transmitting device may encode information bits of an information payload that are mapped to less reliable coding levels with more complex coding schemes to increase a reliability of those information bits. Likewise, the transmitting device may encode information bits mapped to more reliable coding levels with less complex coding schemes such that encoding and decoding complexity may be reduced.

In wireline communications systems that implement MLC schemes (e.g., communications via ethernet, among others), channel conditions between devices may be relatively constant. As such, the coding rates of the wireline communications system may be computed and tested offline (e.g., preconfigured or standardized) to obtain the information bit allocations among the different coding schemes and corresponding coding levels. For example, in the wireline communications system, the transmitting device may allocate the information bits to one or more coding schemes associated with one or more coding levels based on the coding rates of the corresponding coding levels. Because the coding rates for each coding level are computed offline, the receiving device may know the information bit allocation without additional signaling from the transmitting device and decode the information bits in accordance with the known information bit allocation.

However, in wireless communications systems, a quantity of information bits to include an information payload, a payload size, coding rates, and modulation orders, among other communication parameters, may be dynamically adapted based on instantaneous channel conditions between wireless devices. Such dynamic adaptations may result in for different combinations of parameters based on instantaneous channel conditions. Pre-configuration, standardization, or otherwise storage of such information bit allocations may be unfeasible (e.g., due to storage constraints) or use large quantities of storage of a wireless device. Additionally, even if information bit-to-coding scheme allocation is dynamically determined by the transmitting device, such information bit allocation information may be unknown to a receiving device to be able to properly decode the information bits. Transmitting such allocation information to the receiving device may increase the signaling overhead and latency of the transmission.

Techniques, systems, and devices are described herein to enable a transmitting device and a receiving device to independently determine information bit-to-coding level allocations based on instantaneous channel conditions, which may support the use of an MLC scheme without the pre-configuration, standardization, storage, or communication of such allocation information. For example, a transmitting device and a receiving device may each compute a coding rate (e.g., information rate, the ratio of information bits to total bits (a value between 0 and 1)) of different coding levels of a coded modulation scheme based on instantaneous channel conditions. Each coding scheme of the MLC scheme may correspond to one or more of the coding levels and the number of information bits encoded and decoded using each coding scheme may be allocated proportionally based on the coding rates of corresponding coding levels.

For example, a greater proportion of the information bits may be allocated to coding schemes corresponding to coding levels having higher coding rates, and vice versa. In some examples, one or more coding levels may also be polarized into multiple polarized coding levels and coding schemes may correspond to one or more polarized coding levels with information bits allocated accordingly.

Because channel conditions between the transmitting device and the receiving device may be known (e.g., determined, communicated, estimated, computed) at each device, each device may be able to independently compute same (e.g., approximately the same) coding rates and determine corresponding information bit-to-coding scheme allocations. Accordingly, a transmitting device and a receiving device may encode and decode information payloads in accordance with an MLC scheme in dynamically changing wireless communications systems to reduce encoding and decoding complexity without increasing signaling overhead and latency or necessitating the pre-configuration, standardization, or storage of information bit-to-coding scheme allocation information.

Aspects of the disclosure are initially described in the context of wireless communications systems. Aspects of the disclosure are additionally described in the context of MLC schemes and a process flow. Aspects of the disclosure are further illustrated by and described with reference to apparatus diagrams, system diagrams, and flowcharts that relate to bit allocations for MLC in wireless communications.

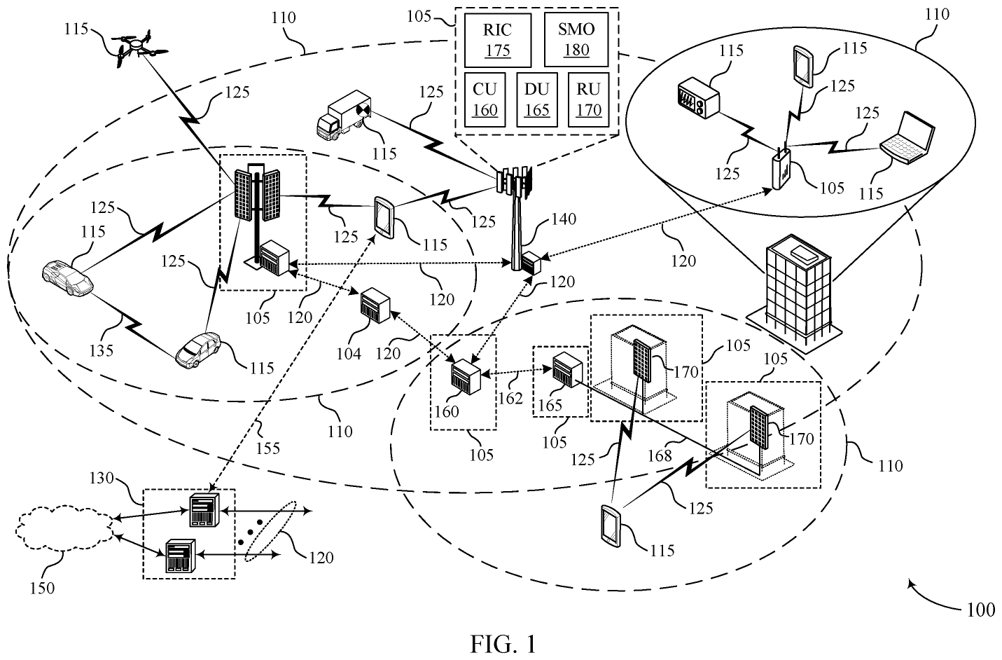

FIG. 1 illustrates an example of a wireless communications system 100 that supports bit allocations for MLC in wireless communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support bit allocations for MLC in wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some implementations of the wireless communications system 100, a first node (e.g., a UE 115, a network entity 105, a transmitting device, an encoding device) may encode information payloads for transmission to a second node (e.g., a UE 115, a network entity 105, a receiving device, a decoding device) in accordance with one or more coding schemes. The second node may receive and decode the information payloads in accordance with the one or more coding schemes. Examples of coding schemes include low-density parity check codes, turbo codes, polar codes, one Reed Solomon codes, staircase codes, rateless codes, product codes, spinal codes, Reed Muller codes, Bose-Chaudhuri-Hocquenghem (BCH) codes, among other coding schemes.

In some examples of polar code implementations, the first node may determine which bits of an information payload are set to non-information bits (e.g., frozen bits), and which set of encoded bits are set to information bits. For example, the first node may recursively allocate information bits to the upper and lower-branches of the polarization transform. The first node may allocate a quantity of information bits to the upper and lower branches based on a coding rate (e.g., mutual information rate) associated with the upper and lower branches, respectively.

In some examples of the wireless communications system 100, a first node and a second node may independently determine information bit-to-coding scheme allocation based on instantaneous channel conditions of the wireless communications system 100, which may support the use of an MLC scheme. For example, the first node and the second node may each compute a coding rate of different coding levels of a coded modulation scheme based on channel conditions of a wireless channel between the first node and the second node. The first node and the second node may each allocate a quantity of information bits to a coding scheme based on the computed coding rates. For example, a greater proportion of the information bits may be allocated to coding schemes corresponding to coding levels having higher coding rates, and vice versa.

The first node may transmit an information payload encoded in accordance with the allocation of the information bits to the second node. The second node may decode the encoded information payload in accordance with the allocation of the information bits, thereby, enabling the first node and the second node to wirelessly communicate the encoded information payload in accordance with an MLC scheme.

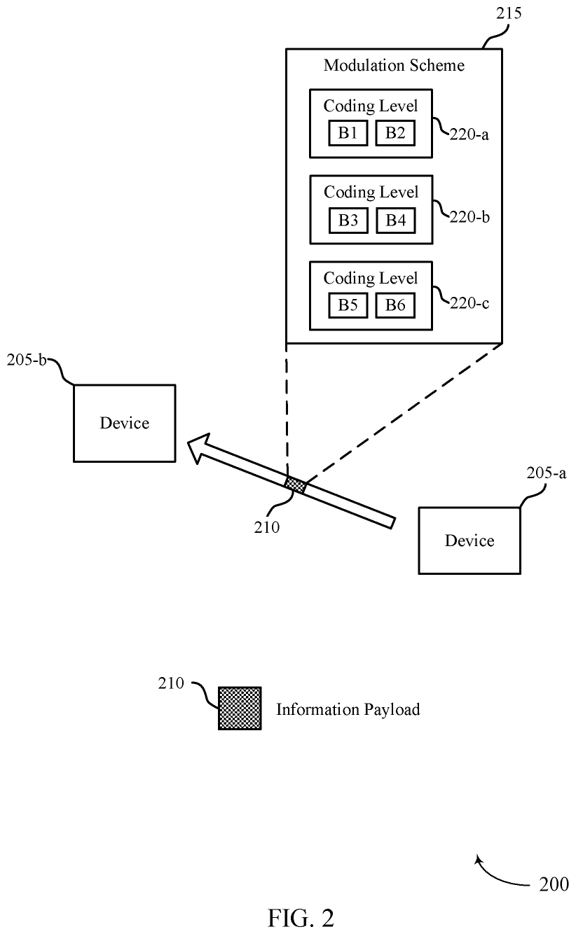

FIG. 2 illustrates an example of a wireless communications system 200 that supports bit allocations for MLC in wireless communications in accordance with one or more aspects of the present disclosure. The wireless communications system 200 may implement or be implemented by aspects of wireless communications system 100. For example, the wireless communications system 200 may include a device 205-a and a device 205-b. In some examples, the devices 205 may be examples of network entities 105 or UEs 115 with reference to FIG. 1. In some other examples, the device 205-a may be an example of a UE 115 and the device 205-b may be an example of a network entity 105, or vice versa.

The device 205-a and the device 205-b may communicate information in accordance with various modulation schemes, such as a modulation scheme 215. The modulation scheme 215 may be a multi-level modulation scheme (e.g., a modulation scheme in which multiple bits are communicated per resource element). The modulation scheme 215 may also be a coded modulation scheme that includes one or more coding levels 220, which may be referred to as modulation levels. For example, in the example of FIG. 2, the modulation scheme 215 may support the modulation of 6 bits B (e.g., bits B1, B2, B3, B4, B5, and B6), although any multi-level modulation schemes may be supported. Each bit B of the modulation scheme 215 may be associated with a respective coding rate (e.g., reliability). For example, some bits B of the modulation scheme 215 may have an increased likelihood of being successfully decoded than other bits B, and thus may have a higher reliability than the other bits B. Accordingly, a first coding rate of a first bit B associated with a first reliability may be greater than a second coding rate of a second bit B associated with a second reliability that is less than the first reliability.

Bits B associated with the same coding rate may correspond to a same coding level 220 of the modulation scheme 215, while bits B associated with different coding rates may corresponding to different coding levels 220. In the example of FIG. 2, bits B1 and B2 may both be associated with a first coding rate, bits B3 and B4 may be associated with a second coding rate, and bits B5 and B6 may be associated with a third coding rate. Accordingly, a bits B1 and B2 may corresponding a coding level 220-a, bits B3 and B4 may be associated with a coding level 220-b, and bits B5 and B6 may be associated with a coding level 220-c.

In a wireline communications system, an encoding device may implement an MLC scheme to transmit an encoded information payload to a receiving device. For example, the encoding device may encode an information payload using different coding rates and schemes across a set of information bits on different coding levels of a modulation scheme. In the MLC scheme, the encoding device may determine how many information bits to transmit on each coding level associated with the coding levels based on the coding rates of each coding level. For example, due to relatively constant channel conditions of a wireline communications system, the coding rates of the wireline communications system may be computed and tested offline to obtain the information bit allocations among the different coding schemes and corresponding coding levels.

However, for the wireless communications system 200, computing information bit allocations offline may be unfeasible or inefficient, for example, due to large quantities of potential information bit allocations that may arise due to communication parameter adaptation for different channel conditions of a wireless channel between the devices 205 and for different payload sizes. To avoid the pre-configuration, standardization, or storage of such potential information bit allocations, an encoding device (e.g., the device 205-a) may transmit an indication of the information bit allocation used to encode an information payload to a decoding device (e.g., the device 205-b), so that the decoding device may properly decode the information payload. However, signaling the information bit allocation may increase signaling overhead and latency in the communications system.

In accordance with examples described herein, the devices 205 may be configured to independently allocate information bits among coding schemes of an MLC scheme based on channel conditions of the wireless channel such that MLC schemes may be supported in wireless communications, for example, without pre-configuration, standardization, storage, or (explicit) communication of such allocation information. For example, the device 205-a and the device 205-b may each compute the coding rates of the coding levels 220 of the modulation scheme 215 based on the channel conditions of the wireless channel, where the channel conditions may include a capacity of the wireless channel, a coding rate associated with the wireless channel, a reliability of the wireless channel, or a combination thereof. Additionally or alternatively, the device 205-a and the device 205-b may compute the coding rates of the coding levels 220 based on a bit-to-constellation mapping of associated with the modulation scheme 215, which may constitute a coding of the modulation scheme 215. For instance, the coding rates of each coding level 220 may depend on how the bits B are mapped within a constellation point of the modulation scheme 215. For example, the devices 205 may use Gray mapping to map the bits B to constellation points such that the bit labeling of adjacent constellations differ by 1 bit. In other examples, the devices 205 may use a set partitioning mapping to map the bits B or a multi-level gray mapping in which, for example, gray mapping is used to map bits B in a same level, while bits across different levels are mapped using set partitioning mapping. In some examples, a coding rate of a given bit B (e.g., and thus the coding rate of the corresponding coding level 220) may be based on the type of mapping used.

In some cases, the device 205-a and the device 205-b may compute the coding rates of the coding levels 220 based on an effective (e.g., average, overall) coding rate across all coding levels 220. For example, the device 205-a and the device 205-b may communicate an indication of an effective coding rate of the wireless channel that is determined, for instance, based on the channel conditions, bit-to-constellation mapping, or a combination thereof. The device 205-a and the device 205-b may compute the coding rates of the coding levels 220 such that an average of the computed coding rates is equal to the effective coding rate. For example, if the effective coding rate of a transmission is R=0.5, the device 205-a and the device 205-b may each compute the coding rate of the coding levels 220-a through 220-c (e.g., R1, R2, R3, respectively) such that the average of R1, R2, and R3 equals R (e.g., average (R1, R2, R3)=R=0.5).

The devices 205 may allocate a quantity of information bits of an information payload 210 among the coding schemes of the MLC scheme based on the computed coding rates. For example, each coding scheme may correspond to one or more of the coding levels 220. The greater the coding rates (e.g., a summation of the coding rates) of the one or more coding levels 220 to which a coding scheme corresponds, the greater the quantity of information bits allocated to the coding scheme, and vice versa.

To communicate the information payload 210 in accordance with the MLC scheme, the device 205-a may encode the information payload using the coding schemes (e.g., with different coding rates and schemes associated with the MLC scheme) in accordance with the allocation of the information bits. The device 205-a may transmit the encoded information payload 210 to the device 205-b which may decode the encoded information payload 210 using the coding schemes and in accordance with the allocation of the information bits. Thus, the device 205-a and the device 205-b may independently determine information bit allocations among coding schemes based on channel conditions to implement an MLC scheme in the wireless communications system 200.

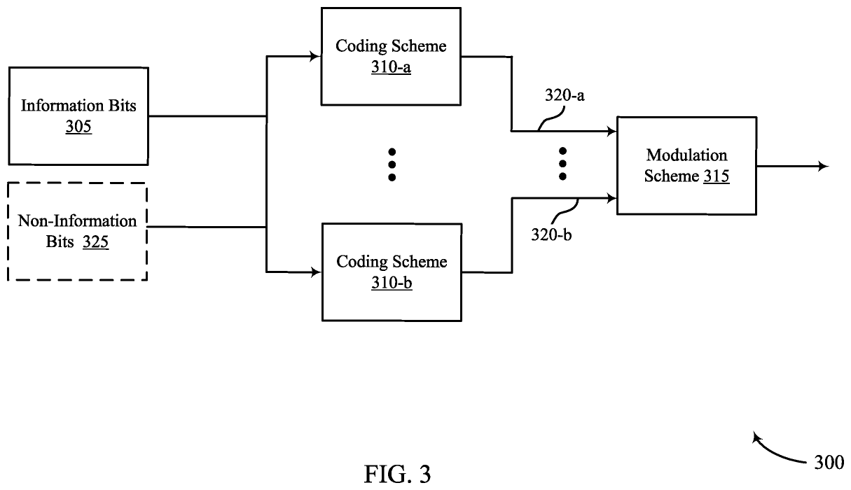

FIG. 3 illustrates an example of an allocation diagram 300 that supports bit allocations for MLC in wireless communications in accordance with one or more aspects of the present disclosure. The allocation diagram 300 may implement or be implemented by aspects of the wireless communications system 100 and the wireless communications system 200 as described herein with reference to FIGS. 1 and 2. For example, the allocation diagram 300 may be implemented by an encoding device, which may be an example of a UE 115, a network entity 105, or a device 205 described herein, including with reference to FIGS. 1 and 2.

The allocation diagram 300 may include information bits 305, one or more coding schemes 310 associated with an MLC scheme, a modulation scheme 315 (e.g., a modulation scheme 215), and one or more coding levels 320 of the modulation scheme 315. The information bits 305 may be bits to be included in an information payload (e.g., an information payload 210) that carry (e.g., convey) information, such as data bits or control bits, among other examples of information bits. In some cases, the allocation diagram 300 may include non-information bits 325, which may correspond to parity bits or frozen bits (e.g., if implementing one or more polar codes).

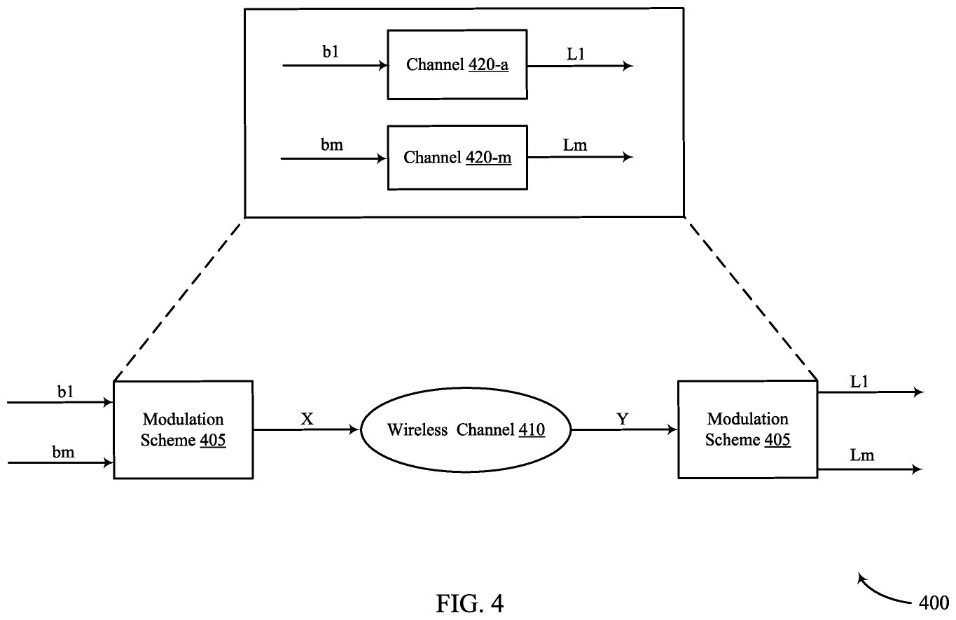

In some implementations of the allocation diagram 300, the encoding device may compute the coding rates of the coding levels 320 based on the channel conditions of a wireless channel between the encoding device and a decoding device and a coding rate of the wireless channel. Additional details related to computing the coding rates of coding levels 320 are described with reference to FIG. 4 below. In the example of FIG. 3, the modulation scheme 315 may include a coding level 320-a up through a coding level 320-b (e.g., the modulation scheme 315 may include any quantity of two or more coding levels 320). The encoding device may determine a quantity of information bits 305 to be transmitted on each coding level 320 based on the computed coding rates.

For example, the coding level 320-a may have a higher coding rate (e.g., channel capacity, reliability) than the coding level 320-b. Thus, the encoding device may determine that the quantity of information bits 305 to be transmitted via the coding level 320-a may be higher than those to be transmitted on the coding level 320-b. In some cases, the quantity of information bits 305 transmitted on each coding level 320 may be proportional to the coding rates of the respective coding levels 320.

In the example of FIG. 3, the MLC scheme may include a coding scheme 310-a up through a coding scheme 310-b (e.g., the MLC scheme may include any quantity of two or more coding schemes 310). Each coding scheme 310 may correspond to one or more coding levels 320, and the encoding device may allocate the information bits 305 among the coding schemes 310 based on the coding rates of the corresponding coding levels 320. For example, in the example of FIG. 3, the coding scheme 310-a may correspond to the coding level 320-a, and the coding scheme 310-b may correspond to the coding level 320-b. The information bits 305 on the coding level 320-a and the information bits 305 on the coding level 320-b may be encoded using the coding scheme 310-a and the coding scheme 310-b, respectively. That is, based on the coding scheme 310-a corresponding to the coding level 320-a and the coding scheme 310-b corresponding to the coding level 320-b, the encoding device may allocate the information bits 305 to be transmitted on the coding level 320-a to the coding scheme 310-a for encoding and allocate the information bits 305 to be transmitted on the coding level 320-b to the coding scheme 310-b for encoding.

The encoding device may determine to use coding schemes of the same type or use different types of codes for the coding scheme 310-a through the coding scheme 310-b. In some examples, a type of coding scheme used may be based on the coding rates to which a coding scheme 310 corresponds. For example, the coding rate of the coding level 320-a may be higher than that of the coding level 320-b, which may correspond to the coding level 320-a having a higher capacity or reliability than that of the coding level 320-b. Thus, the encoding device may determine to use a coding scheme 310-a that is less complex than the coding scheme 310-b to encode the information bits 305 based on the higher coding rate of the coding level 320-a. As a result, receiver complexity may be reduced, for example, compared to a case of using a single code across all coding levels 320. In some examples, a coding scheme 310 may be an unencoded coding scheme based on coding rates of associated coding levels 320. For example, to further reduce receiver complexity, the coding scheme 310-a may be an unencoded coding scheme (e.g., a coding scheme in which information bits are passed through without encoding) based on a coding rate of the coding level 320-a satisfying a threshold. For instance, the coding rate of the coding level 320-a satisfying the threshold may indicate that the coding level 320-a is associated with few errors (e.g., approximately error free). Accordingly, the coding scheme 310-a may be an unencoded coding scheme to reduce receiver complexity with relatively low risk that there will be errors with the information bits allocated to the coding scheme 310-a.

In some cases, the quantity of coding schemes 310 may be less than or equal to the quantity of coding levels 320. In an example in which there are fewer coding schemes 310 than coding levels 320, one or more coding schemes 310 may be used jointly across multiple coding levels 320. For example, in an example of the modulation scheme 315 being a 64 QAM modulation scheme, the modulation scheme 315 may include three unequal coding levels 320, however, the encoder may determine to use two coding schemes 310. Here, a first coding scheme 310 may be used jointly across the first and second coding levels 320, while a second coding scheme 310 may be used for the third coding level 320. Accordingly, information bits 305 may be allocated to the first coding scheme 310 based on a combination of the coding rates of the first and second coding levels 320, while information bits 305 may be allocated to the second coding scheme 310 based on the coding rate of the third coding level 320.

In some examples, the encoding device may allocate non-information bits 325 among the coding schemes 310 based on the coding rates of the corresponding coding levels 320. For example, the encoding device may proportionally allocate parity bits among the coding schemes based on the coding rates of the corresponding coding levels 320. In some examples in which one or more coding schemes 310 are polar coding schemes, at least a subset of the non-information bits 325 may be frozen bits. Here, the subset of frozen bits may be allocated inversely proportionate to the coding rates. That is, the higher the coding rates of coding levels 320 to which a polar coding scheme 310 corresponds, the fewer the quantity of frozen bits allocated to the polar coding scheme 310.

To the encode and transmit an information payload in accordance with the MLC scheme, the encoding device may allocate the information bits 305 (e.g., and the non-information bits 325) among the coding schemes 310 based on computed coding level coding rates, encode the information bits 305 using the coding schemes 310 in accordance with the allocation, modulate the encoded information bits 305 in accordance with modulation scheme 315, and transmit the information payload including the encoded and modulated information bits 305 to the decoding device via the wireless channel. To receive and decode the information payload, the receiving device may receive the information payload, demodulate the information payload in accordance with the modulation scheme 315, allocate information bits 305 (e.g., and non-information bits 325) among the coding schemes 310 based on computed coding level coding rates, and decode the information payload (e.g., the information bits 305) using the coding schemes 310 in accordance with the allocation. In this way, the encoding device and the decoding device may communicate, via a wireless channel, information payloads encoded in accordance with an MLC scheme without the pre-configuration, standardization, storage, or communication of information bit allocation information.

FIG. 4 illustrates an example of a wireless communications system 400 that supports bit allocations for MLC in wireless communications in accordance with one or more aspects of the present disclosure. The wireless communications system 400 may implement or be implemented by aspects of the wireless communications systems 100 and 200. For example, the wireless communications system 400 may include a modulation scheme 405, which may be implemented by an encoding device and a decoding device described herein, including with reference to FIGS. 1 through 3. Additionally, the modulation scheme 405 may be an example of a modulation scheme described herein, including with reference to FIGS. 1 through 3.

In the example of the wireless communications system 400, the encoding device and decoding device may compute the coding rates for one or more coding levels of the modulation scheme 405. For example, the encoding device and the decoding device may map m bits (e.g., b₁, b₂, . . . , bₘ) to a constellation point X of the modulation scheme 405. The encoding device and the decoding device may assume that X has an average power of 1 and is communicated over the wireless channel 410. The wireless channel 410 may be an example of an additive white Gaussian noise (AWGN) channel with a signal-to-noise ratio (SNR) of ρ. Thus, the encoding device and the decoding device may compute the mutual information between each of the m bits (b₁, b₂, . . . , bₘ) and an output Y of the wireless channel 410 (e.g., the received signal Y, where X is the transmitted signal), where Y=\sqrt{ρ}X+Z. Here, Z denotes the AWGN noise and may be assumed to be the complexity Gaussian distributed with zero mean unit variance. The bits L₁ through Lₘ may correspond to the bits b₁ through bₘ, respectively, that are demodulated by the decoding device after being communicated over the wireless channel 410. The mutual information between a bit b and the output Y may correspond to a coding rate of the bit b transmitted via the wireless channel 410. Thus, both the encoding device and decoding device may determine the coding rates of the m bits b transmitted via the wireless channel 410.

The encoding device and the decoding device may compute the coding rates of the m bits b according to various techniques. For example, the mutual information I(X;Y) of two jointly discrete random variables X and Y may be calculated according to Equation 1 below, whereas the mutual information I(X;Y) of two jointly continuous random variables X and Y according to Equation 2 below:

$$I ( X ; Y ) = {\sum }_{y ∈ Y} {\sum }_{x ∈ X} {p}_{( X , Y )} ( x , y ) log ( \frac{{p}_{( X , Y )} ( x , y )}{{p}_{X} ( x ) {p}_{Y} ( y )} ) \qquad ( 1 )$$

$$I ( X ; Y ) = {\int }_{x} {\int }_{y} {p}_{( X , Y )} ( x , y ) log ( \frac{{p}_{( X , Y )} ( x , y )}{{p}_{X} ( x ) {p}_{Y} ( y )} ) \qquad ( 2 )$$

In each of Equations 1 and 2, p_{(X,Y)} is the joint probability mass/distribution function of X and Y, and p_{X} and p_{Y} are the marginal probability mass/distribution functions of X and Y, respectively.

In some examples, the encoding device and the decoding device may calculate a conditional mutual information of each of the m bits b based on excluding bits values of other modulation bits from the computation of the mutual information. For example, the encoding device and the decoding device may calculate the conditional mutual for a bit bⱼ according to Iⱼ=I(bⱼ; Y|b₁, . . . , bⱼ₋₁), where the impact of bits b₁ through bⱼ₋₁, is removed or canceled from the received signal Y in the calculation of the mutual information Iⱼ. For instance, if the decoding device uses multi-stage decoding to demodulate the bit bⱼ the impact from layer 1 to layer j−1 is removed or canceled. Accordingly, removing or canceling the impact of bits b₁ through bⱼ₋₁ in the calculation of the mutual information Iⱼ may increase an accuracy of the calculated mutual information.

Alternatively, the encoding device and the decoding device may calculate an unconditional mutual information of each of the m bits b based on bit values of modulation bits corresponding to less significant bits than a given modulation bit. For example, the encoding device and the decoding device may calculate the unconditional mutual for a bit b; according to Iⱼ=I(bⱼ;Y), where the impact of bits b₁ through bⱼ₋₁ is not removed or canceled in the calculation of the mutual information Iⱼ. For instance, in an example of implementing coded modulation, the decoding device may use a single stage demodulator that outputs the log-likelihood ratios (LLRs) for modulation bits on different levels at the same time.

Additionally, the encoding device and the decoding device may compute the mutual information for each of the m bits b such that a summation of computed mutual information (e.g., a summation of the coding rates) is equal to a quantity of coding levels of the modulation scheme 405 multiplied by an effective coding rate of the wireless channel 410. For example, the encoding device and the decoding device may communicate an indication of the effective coding rate R of the wireless channel 410. The encoding device and the decoding device may compute the SNR parameter ρ by selecting ρ such that ΣIⱼ=m*R, where m denotes the quantity of coding levels. The effective coding rate R of the wireless channel 410 may be determined based on channel conditions of the wireless channel 410.

In some examples, the m bits b may be seen as being communicated via a set of m parallel binary-input channels 420, whose coding rates are {Iⱼ}. For example, the computation of the coding rates for each of the m bits b may be viewed as computing the coding rate of parallel channels 420-a through 420-m via which the bits b₁ through bₘ are communicated.

By computing the mutual information between each of the m bits b and the output Y, the encoding device and the decoding device may compute the coding rates for each of the m bits b. For example, the mutual information between a bit b and the output Y may be the coding rate of the bit b. That is, a coding rate R₁ of bit b₁ may equal the mutual information I₁ between b₁ and Y. The encoding device and the decoding device may compute the coding rates for each coding level of the modulation scheme 405 based on the coding rates of the bits b. For example, bits b having a same computed coding rate may correspond to a same coding level, while bits b having different computed coding rates may correspond to different coding levels. Accordingly, a coding rate of a coding level may correspond to a coding rate of the one or more bits b of the coding level.

The encoding device and the decoding device may additionally allocate information bits among the modulation bits of the modulation scheme 405 based on the computed coding rates. For example, if the encoding device and the decoding device are to communicate K information bits via an information payload, where K is some positive integer, the encoding device and the decoding device may allocate

$$K * \frac{{I}_{j}}{{\sum }_{i = 1}^{m} {I}_{i}}$$

information bits to be communicated using the bit bⱼ. Based on the quantity of bits in a given coding level, the encoding device and the decoding device may allocate information bits to the given coding level. For example, if a first coding level includes bits bⱼ,

$$K * \frac{{I}_{j}}{{\sum }_{i = 1}^{m} {I}_{i}}$$

information bits may be allocated to the coding level, whereas if a second coding level include bits bₖ and bₖ₊₁, each with a mutual information of Iₖ,

$$K * \frac{2 * {I}_{j}}{{\sum }_{i = 1}^{m} {I}_{i}}$$

information bits may be allocated to the coding level.

To support the implementation of an MLC scheme to communicate the information payload, the encoding device and the decoding device may allocate the K information bits among coding schemes of the MLC scheme based on a ratio of a summation of the coding rates corresponding to the coding scheme to a summation of each of the coding rates. For example, if a coding scheme corresponds to the first coding level and the second coding level,

$$K * \frac{{I}_{j} + 2 * {I}_{k}}{{\sum }_{i = 1}^{m} {I}_{i}}$$

information bits may be allocated to the coding scheme.

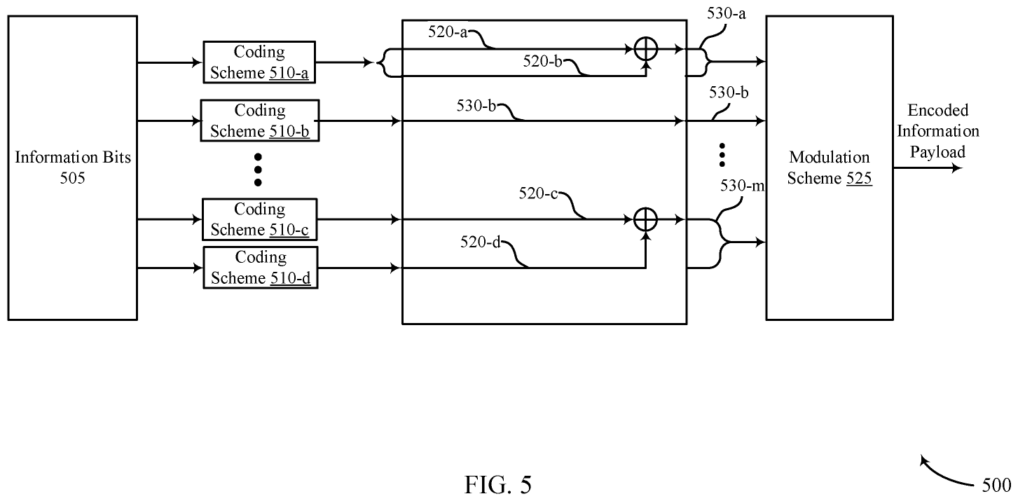

FIG. 5 illustrates an example of an allocation diagram 500 that supports bit allocations for MLC in wireless communications in accordance with one or more aspects of the present disclosure. The allocation diagram 500 may implement or be implemented by aspects of the wireless communications systems 100, 200, and 400. For example, the allocation diagram 500 may be implemented by an encoding device, which may be an example of a UE 115, a network entity 105, a device 205, or an encoding device described herein, including with reference to FIGS. 1 through 4.

The allocation diagram 500 may include one or more coding schemes 510 associated with an MLC scheme implemented by the encoding device (e.g., coding schemes 510-a through 510-d), which may be examples of coding schemes described herein, including with reference to FIGS. 1 through 4. Likewise, the allocation diagram 500 may include a modulation scheme 525, which may be an example of modulation schemes described herein, including with reference to FIGS. 1 through 4. The modulation scheme 525 may include multiple coding levels 530 (e.g., m coding levels 530, coding level 530-a through 530-m), which may be examples of coding levels described herein, including with reference to FIGS. 1 through 4.

In the example of FIG. 5, the encoding device may combine polarization with the MLC scheme and allocate information bits 505 to the coding schemes 510 based on the polarization. For example, the encoding device may polarize one or more coding levels 530 of the modulation scheme 525. For instance, the encoding device may polarize each of the m coding levels 530 of the modulation scheme 525 into m*Q polarized coding levels 520, where Q is the quantity of polarization levels. For example, in an example of the allocation diagram 500, the modulation scheme 525 may include two coding levels 530: coding level 530-a and coding level 530-m. The encoding device may polarize the coding level 530-a into a polarized coding level 520-a and a polarized coding level 520-b. Likewise, the encoding device may polarize the coding level 530-m into a polarized coding level 520-c and a polarized coding level 520-d. Here, m=2 coding levels 530 and Q=2 polarization level. Thus, the two coding levels 530 may be polarized into m*Q=4 polarized coding levels 520.

The encoding device may compute a coding rate of each polarized coding level 520. For example, the encoding device may compute the coding rates of the coding levels 530-a and 530-m. The coding rates of the polarized coding levels 520-a and 520-b may correspond to the coding rate of the coding level 530-a polarized into a first polarized coding rate and a second polarized coding rate, respectively. Similarly, the coding rates of the polarized levels 520-c and 520-d may correspond to the coding rate of the coding level 530-m polarized into a third polarized coding rate and a fourth polarized coding rate, respectively.

The polarized coding rates computed for each polarized coding level 520 may be based on how modulation bits of the modulation scheme 525 are combined in the process of polarization. For example, in an example in which the modulation scheme 525 is a 16 QAM scheme, the modulation scheme 525 may include the two coding levels (e.g., coding levels 530-a and 530-m) each of which include two bits. Each bit of the two coding levels 530 may have a same coding rate. For example, a coding rate of a first and second bit of the coding level 530-a may be R1=0.7, and a coding rate of a first and second bit of the coding level 530-m may be R2=0.3. In a first example of polarizing the bits of the modulation scheme 525, each bit of the modulation scheme 525 may be associated with a respective bit channel having a corresponding coding rate (e.g., R1 or R2). The encoding device may combine the bit channels with coding rates R1 with the bit channels with coding rates R2 to generate two polarized bit channels having coding rates R1ₚ₁ of, for example, 0.79 and two polarized bit channels having coding rates R2ₚ₁ of, for example, 0.21. The encoding device may then combine the two polarized bit channels having coding rates R1ₚ₁ with each other to generate a first polarized bit channel having coding rate of R1ₚ₂=0.95 and a second polarized bit channel having a coding rate R1ₚ₃=0.62. The encoding device may also combine the two polarized bit channels having coding rates R2ₚ₁ with each other to generate a third polarized bit channel having a coding rate of R2ₚ₂=0.38 and a fourth polarized bit channel having a coding rate R2ₚ₃=0.04. In this example, the coding rate of the polarized coding level 520-a may be R1ₚ₂=0.95, the coding rate of the polarized coding level 520-b may be R1ₚ₃=0.62, the coding rate of the polarized coding level 520-c may be R2ₚ₂=0.38, the coding rate of the polarized coding level 520-d may be R2ₚ₃=0.04.

In a second example of polarizing the bits of the modulation scheme 525, bit channels having coding rates R1=0.7 and bit channels having coding rates R2=0.3 may first be combined with each other, which may result in a first polarized bit channel having coding rate of R1ₚ₁=0.91, a second polarized bit channel having a coding rate R1ₚ₂=0.49, a third polarized bit channel having a coding rate of R2ₚ₁=0.51 and a fourth polarized bit channel having a coding rate R2ₚ₂=0.09. Then, the first and third polarized bit channels may be combined such that R1ₚ₁=0.96 and R2ₚ₁=0.46, and the second and fourth polarized bit channels may be combined such that R1ₚ₂=0.54 and R2ₚ₂=0.04. Here, the coding rate of the polarized coding level 520-a may be R1ₚ₁=0.96, the coding rate of the polarized coding level 520-b may be R1ₚ₂=0.54, the coding rate of the polarized coding level 520-c may be R2ₚ₁=0.46, the coding rate of the polarized coding level 520-d may be R2ₚ₂=0.04. Thus, the polarized coding rates computed for each polarized coding level 520 may be based on how modulation bits of the modulation scheme 525 are combined in the process of polarization.

Each coding scheme 510 of the MLC scheme may be associated with one or more of the polarized coding levels 520. For instance, the encoding device may partition the polarized coding levels 520 into one or more coding schemes 510. For example, the coding scheme 510-a may be associated with the polarized coding level 520-a and the polarized coding level 520-b. Likewise, a coding scheme 510-c may be associated with the polarized coding level 520-c, and the coding scheme 510-d may be associated with the polarized coding level 520-d. Accordingly, based on polarizing the coding levels 530, a quantity of coding schemes 510 may be less than, the same as, or greater than the quantity of coding levels 530 (e.g., less than or equal to the quantity of polarized coding levels 520).

The encoding device may allocate information bits 505 (e.g., an non-information bits) among the coding schemes 510 based on coding rates of the associated polarized coding levels. For example, because the coding scheme 510-a is associated with the polarized coding level 520-a and the polarized coding level 520-b, the encoding device may take the sum of the coding rates across the polarized coding levels 520-a and 520-b to be the coding rate associated with the coding scheme 510-a and allocate the information bits 505 accordingly. Similarly, because the coding schemes 510-c and 510-d are associated with the polarized coding levels 520-c and 520-d, respectively, the coding rates associated with the coding schemes 510-c and 510-d may be the coding rates of the polarized coding levels 520-c and 520-d, respectively, and information bits 505 may be allocated accordingly.

For example, in an illustrative example, the encoding device may encode and transmit N=4000 coded bits in an information payload. In this example, a coding rate R of a wireless channel between the encoding device and a decoding device may be determined to be R=0.5 (e.g., based on channel conditions of the wireless channel). Accordingly, there may be K=2000 information bits of the N=4000 coded bits to encode and transmit in the information payload. The encoding device may compute a coding rate R1 of the coding level 530-a and a coding rate R2 of the coding level 530-m, for example, to be R1=0.7 and R2=0.3 (e.g., such that (R1+R2)/2=R). The polarized coding rates for the polarized coding levels 520-a, 520-b, 520-c, and 520-d may be computed to be, for example, PR1=0.5, PR2=0.9, PR3=0.1 and PR4=0.5, respectively (e.g., such that (PR1+PR2)/2=R1 and (PR3+PR4)/2=R2). The K information bits may be allocated amongst the coding schemes 510 based on the polarized coding rates PR. For example, the encoding device may allocate 1400 of the 2000 information bits to the coding scheme 510-a (e.g., (PR1+PR2)/2=0.7; 70% of the information bits), 100 information bits of the 2000 information bits to the coding scheme 510-c (e.g., PR3/2=0.05; 5% of the information bits), and 500 information bits of the 2000 information bits to the coding scheme 510-d (e.g., PR4/2=0.25; 25% of the information bits). The encoding device may encode the information payload in accordance with the information bit allocation and transmit the information payload to the decoding device. The decoding device may similarly polarize coding levels 530 into polarized coding levels 520, compute coding rates of the polarized coding levels 520, and allocate information bits accordingly to decode the information payload. In some cases, the encoding device may use partial polarization to polarize a subset of the coding levels 530. For example, in another example of the allocation diagram 500, the modulation scheme 525 may include three coding levels 530: coding level 530-a, coding level 530-b, and coding level 530-m. Here, the encoding device may polarize a subset of the coding levels 530, such as the coding levels 530-a and 530-m (e.g., into the polarized coding levels 520-a, 520-b and 520-c, 520-d, respectively) while the coding level 530-b may not be polarized into any additional polarized coding levels 520. Thus, the information bits 505 allocated to the coding scheme 510-b corresponding to the coding level 530-b may be directly mapped to the coding level 530-b. Here, information bits 505 may be allocated to the coding schemes 510-a through 510-d based on the coding rates of one or more polarized coding levels 520, one or more coding levels 530, or a combination thereof, to which the coding schemes 510 correspond.

In some cases, the encoding device may use a polar coded modulation scheme to polarize the coding levels 530 and allocate the information bits 505 (e.g., and non-information bits) among the coding schemes 510. For example, the coding schemes 510-a to 510-d may each correspond to a subpolar code of a joint polar code. That is, different information bits 505 (e.g., and non-information bits corresponding to frozen bits) communicated on different coding levels 530 may be jointly encoded using the joint polar code (e.g., a polar code may be used to jointly encode bits allocated amongst the coding schemes 510-a through 510-d).

The encoding device and the decoding device may allocate a quantity of the information bits 505 and a quantity of non-information (e.g., frozen bits) to each coding scheme 510 (e.g., the subpolar codes) based on the respective coding rates of the coding levels 530 (e.g., coding rates of the polarized coding levels 520) to which each coding scheme 510 corresponds. Each subpolar code may be associated with a respective polar sequence which the encoding device and decoding device may use to determine allocations of the frozen bits and the information bits 105 within each respective coding scheme 510. Polar sequence lengths may be reduced based on each subpolar code being associated with a respective polar sequence. For example, in an example in which the information bits 505 and non-information bits are allocated amongst four different subpolar codes (e.g., corresponding to coding schemes 510-a through 510-d), a length polar sequence applied across all bits mapping to all coding levels 530 may be longer (e.g., 4 times longer) than a polar sequence associated with a subpolar code. Thus, encoding/decoding complexity may be reduced by implementing a joint polar code including subpolar codes and allocation information bits 505 and non-information bits amongst the subpolar codes based on coding rates of corresponding coding levels 530 (e.g., polarized coding levels 520).

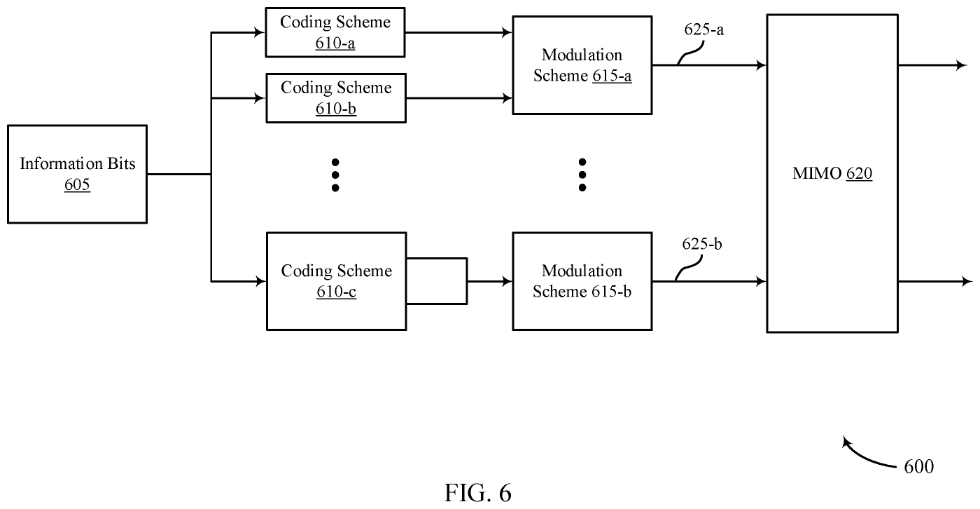

FIG. 6 illustrates an example of an allocation diagram 600 that supports bit allocations for MLC in wireless communications in accordance with one or more aspects of the present disclosure. The allocation diagram 600 may implement or be implemented by aspects of wireless communications systems 100, 200, and 400. For example, the allocation diagram 600 may be implemented by an encoding device, which may be an example of a UE 115, a network entity 105, a device 205, or an encoding device described herein, including with reference to FIGS. 1 through 5.

The allocation diagram 600 may include one or more coding schemes 610 associated with an MLC scheme implemented by the encoding device (e.g., coding schemes 610-a through 610-c), which may be examples of coding schemes described herein, including with reference to FIGS. 1 through 5. Additionally, the allocation diagram 600 may include one or more modulation schemes 615, which may be examples of modulation schemes described herein, including with reference to FIGS. 1 through 5.

In some implementations, an encoding device and a decoding device may support MIMO communications. For example, the encoding device may communicate with the decoding device via multiple spatial layers 625, such as a spatial layer 625-a and a spatial layer 625-b of a MIMO system 620. Communications via the spatial layer 625-a may be modulated according to the modulation scheme 615-a, and communications via the spatial layer 625-b may be modulated according to the modulation scheme 615-b. The modulation scheme 615-a and the modulation scheme 615-b may each include one or more coding levels. Each coding scheme 610 may be associated with one or more coding levels of a modulation scheme 615. For example, the coding scheme 610-a may be associated with a first coding level of the modulation scheme 615-a, the coding scheme 610-b may be associated with second coding level of the modulation scheme 615-a, and the coding scheme 610-c may be associated with a first and second coding level of the modulation scheme 615-b.

The encoding device may compute the coding rate of the spatial layer 625-a and the spatial layer 625-b based on channel conditions of a wireless channel between the encoding device and the decoding device. The encoding device may also compute the coding rates of the coding levels of the modulation schemes 615, for example, based on the coding rates of the respective spatial layers 625. The encoding device may allocate the information bits 605 to the coding schemes 610 in accordance with the computed coding rates of the corresponding coding levels. To transmit an information payload via the MIMO system 620 in accordance with the MLC scheme, the encoding device may encode information bits using the coding schemes 610 in accordance with the information bit allocation, modulate the encoded information bits using the corresponding modulation schemes 615, and transmit the encoded information payload via the spatial layers 625 to the decoding device. The decoding device may similarly compute the coding rates of the spatial layers and coding levels, allocate the information bits to corresponding coding schemes, and decode the information payload in accordance with the information bit allocation. Thus, the decoding device may receive the encoded information payload and successfully decode the information bits in accordance with an MLC scheme.

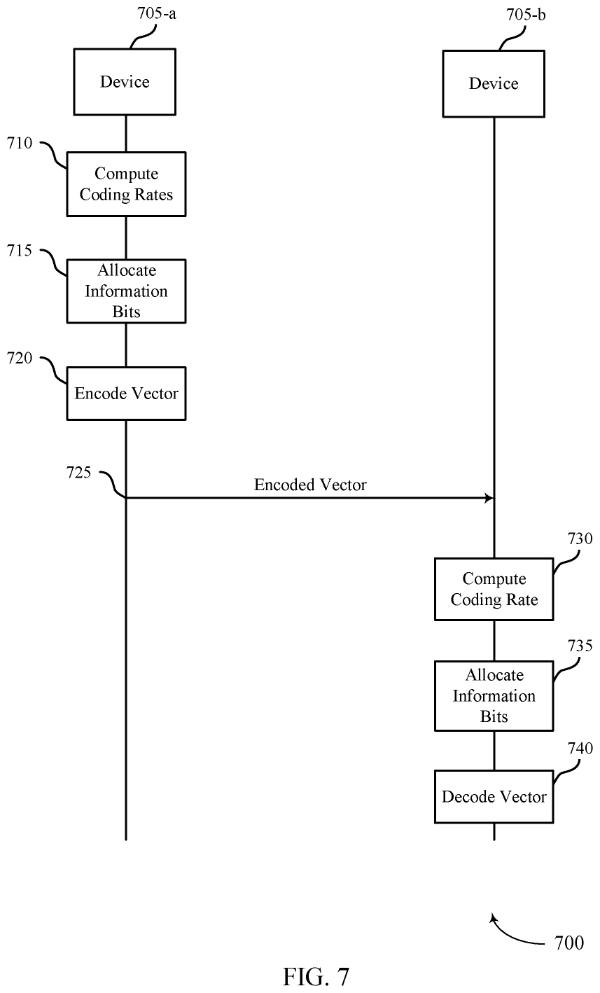

FIG. 7 illustrates an example of a process flow 700 that supports bit allocations for MLC in wireless communications in accordance with one or more aspects of the present disclosure. The process flow 700 may implement or be implemented by aspects of the wireless communications system 100, 200, and 400. For example, the process flow 700 may be implemented by a device 705-a and a device 705-b, which may be examples of a UE 115, a network entity 105, a device 205, an encoding device, or a receiving device described herein, including with reference to FIGS. 1 through 6.

In the following description of the process flow 700, the operations may be performed in different orders or at different times. Some operations also may be omitted from the process flow 700, and other operations may be added to the process flow 700. Further, although some operations or signaling may be shown to occur at different times for discussion purposes, these operations may actually occur at the same time.

At 710, the device 705-a may compute a coding rate associated with each coding level of a coded modulation scheme based on one or more channel conditions of a wireless channel between the device 705-a and the device 705-b. In some cases, the device 705-a may compute the coding rates associated with a set of modulation bits of the coded modulation scheme. Here, each coding level corresponds to one or more modulation bits, and the coding rate associated with each coding level is a coding rate associated with the one or more modulation bits.

In some examples, the device 705-a may compute the coding rate associated with a modulation bit based on bit values of modulation bits corresponding to less significant bits than the modulation bit (e.g., compute the unconditional mutual information of the modulation bit). In some other examples, the device 705-a may compute the coding rate associated with a modulation bit based on excluding bit values of other modulation bits from the computation of the coding rate associated with the modulation bit (e.g., compute the conditional mutual information of the modulation bit). In some cases, the device 705-a may compute the coding rate such that a summation of the set of coding rates is equal to a quantity of the coding levels multiplied by a coding rate of the wireless channel.

At 715, the device 705-a may allocate a set of information bits among coding schemes of an MLC scheme used to communicate an information payload between the device 705-a and the device 705-b. The quantity of information bits allocated to each coding scheme may be based on the coding rates associated with the one or more coding levels corresponding to the coding schemes. For example, the quantity of information bits allocated to each coding scheme may be proportional to the coding rates corresponding to each coding scheme. For instance, the quantity of information bits allocated to each coding scheme may be based on a ratio of a summation of the coding rates corresponding to the coding scheme to a summation of each of the coding rates.

In some cases, the device 705-a may polarize the coding levels into a set of polarized coding levels, which each have a respective second coding rate. In some other cases, the device 705-a may polarize a subset of coding levels into a set of polarized coding levels, which may each have a respective second coding rate. Thus, each coding scheme may correspond to one or more non-polarized coding levels, one or more polarized coding levels, or a combination thereof. The quantity of information bits allocated to each coding scheme may be based on a combination of the coding rates and second coding rates to which the coding scheme corresponds.

At 720, the device 705-a may encode an information payload using the coding schemes in accordance with the allocation of the information bits. In some examples, one or more of the coding schemes may be examples of an unencoded scheme based on the coding rates corresponding to the one or more coding schemes satisfying a threshold.

In some examples, the coding schemes may include one or more a LDPC codes, one or more turbo codes, one or more polar codes, one or more Reed Solomon codes, one or more staircase codes, one or more rateless codes, one or more product codes, one or more spinal codes, one or more Reed Muller codes, one or more BCH codes, or any combination thereof. Alternatively, the coding schemes may include multiple polar codes or joint polar codes that include multiple subpolar codes.

At 725, the device 705-a may transmit, and the device 705-b may receive, the encoded information payload via the wireless channel.

At 730, the device 705-b may compute the coding rate associated with each coding level of the coded modulation scheme based on the one or more channel conditions of the wireless channel.

At 735, the device 705-b may allocate information bits of the information payload among the coding schemes of the MLC scheme based on the coding rates associated with the one or more coding levels to which the coding schemes correspond.

At 740, the device 705-b may decode the information payload using the coding schemes in accordance with the allocation of the information bits.

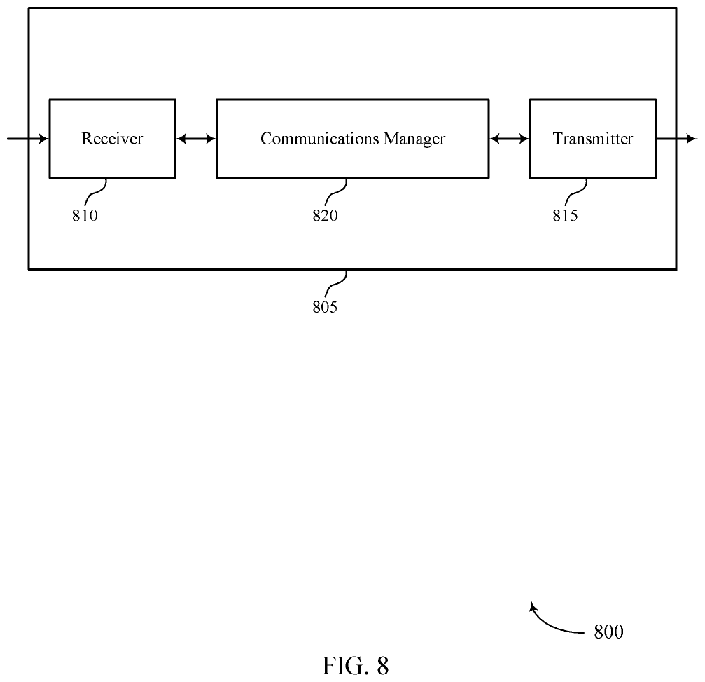

FIG. 8 shows a block diagram 800 of a device 805 that supports bit allocations for MLC in wireless communications in accordance with one or more aspects of the present disclosure. The device 805 may be an example of aspects of a UE 115, a network entity 105, or a device (e.g., a device 205, an encoding device, a decoding device) as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to bit allocations for MLC in wireless communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to bit allocations for MLC in wireless communications). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of bit allocations for MLC in wireless communications as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 may be configured as or otherwise support a means for computing a coding rate associated with each coding level of a coded modulation scheme based on one or more channel conditions of a wireless channel. The communications manager 820 may be configured as or otherwise support a means for allocating a set of multiple information bits among a set of multiple coding schemes associated with a MLC scheme, where a quantity of information bits allocated to each coding scheme is based on the coding rates associated with one or more coding levels corresponding to the coding scheme. The communications manager 820 may be configured as or otherwise support a means for encoding an information payload using the set of multiple coding schemes in accordance with the allocation of the set of multiple information bits. The communications manager 820 may be configured as or otherwise support a means for transmitting the encoded information payload via the wireless channel.

Additionally, or alternatively, the communications manager 820 may support wireless communication in accordance with examples as disclosed herein. For example, the communications manager 820 may be configured as or otherwise support a means for receiving an information payload of encoded bits via a wireless channel. The communications manager 820 may be configured as or otherwise support a means for computing a coding rate associated with each coding level of a coded modulation scheme based on one or more channel conditions of the wireless channel. The communications manager 820 may be configured as or otherwise support a means for allocating a set of multiple information bits among a set of multiple coding schemes associated with a MLC scheme, where each coding scheme corresponds to one or more coding levels of the coded modulation scheme, and where a quantity of information bits allocated to each coding scheme is based on the coding rates associated with the one or more coding levels corresponding to the coding scheme. The communications manager 820 may be configured as or otherwise support a means for decoding the information payload using the set of multiple coding schemes in accordance with the allocation of the set of multiple information bits.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reducing processing power for encoding information bits.

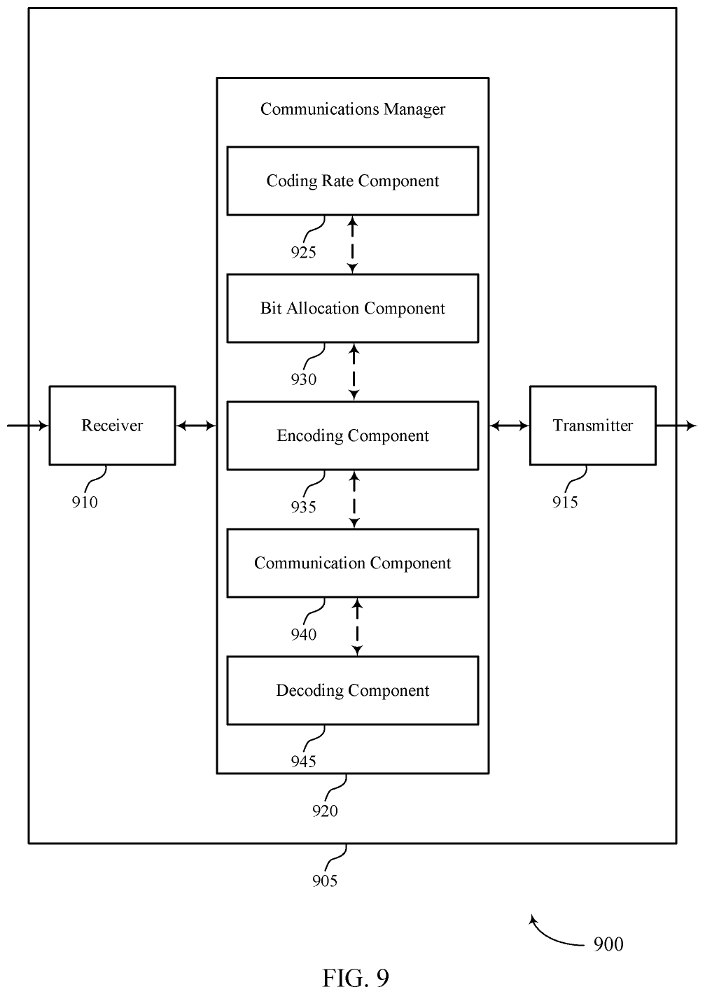

FIG. 9 shows a block diagram 900 of a device 905 that supports bit allocations for MLC in wireless communications in accordance with one or more aspects of the present disclosure. The device 905 may be an example of aspects of a device 805, a UE 115, a network entity 105, or a device 205 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to bit allocations for MLC in wireless communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to bit allocations for MLC in wireless communications). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of bit allocations for MLC in wireless communications as described herein. For example, the communications manager 920 may include a coding rate component 925, a bit allocation component 930, an encoding component 935, a communication component 940, a decoding component 945, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The coding rate component 925 may be configured as or otherwise support a means for computing a coding rate associated with each coding level of a coded modulation scheme based on one or more channel conditions of a wireless channel. The bit allocation component 930 may be configured as or otherwise support a means for allocating a set of multiple information bits among a set of multiple coding schemes associated with a MLC scheme, where a quantity of information bits allocated to each coding scheme is based on the coding rates associated with one or more coding levels corresponding to the coding scheme. The encoding component 935 may be configured as or otherwise support a means for encoding an information payload using the set of multiple coding schemes in accordance with the allocation of the set of multiple information bits. The communication component 940 may be configured as or otherwise support a means for transmitting the encoded information payload via the wireless channel.

Additionally, or alternatively, the communications manager 920 may support wireless communication in accordance with examples as disclosed herein. The communication component 940 may be configured as or otherwise support a means for receiving an information payload of encoded bits via a wireless channel. The coding rate component 925 may be configured as or otherwise support a means for computing a coding rate associated with each coding level of a coded modulation scheme based on one or more channel conditions of the wireless channel. The bit allocation component 930 may be configured as or otherwise support a means for allocating a set of multiple information bits among a set of multiple coding schemes associated with a MLC scheme, where each coding scheme corresponds to one or more coding levels of the coded modulation scheme, and where a quantity of information bits allocated to each coding scheme is based on the coding rates associated with the one or more coding levels corresponding to the coding scheme. The decoding component 945 may be configured as or otherwise support a means for decoding the information payload using the set of multiple coding schemes in accordance with the allocation of the set of multiple information bits.

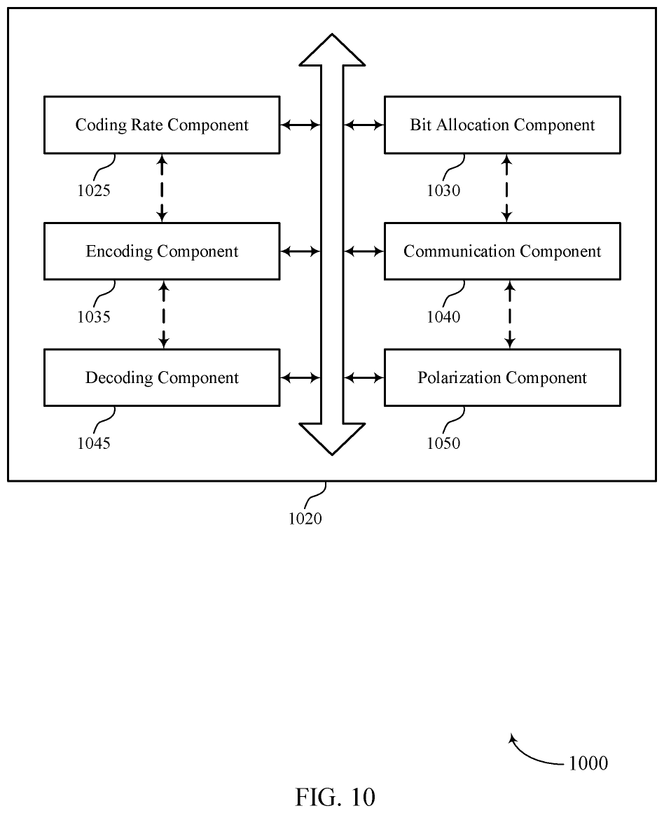

FIG. 10 shows a block diagram 1000 of a communications manager 1020 that supports bit allocations for MLC in wireless communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of bit allocations for MLC in wireless communications as described herein. For example, the communications manager 1020 may include a coding rate component 1025, a bit allocation component 1030, an encoding component 1035, a communication component 1040, a decoding component 1045, a polarization component 1050, or any combination thereof. Each of these components may communicate, directly or indirectly, with one another (e.g., via one or more buses).

The communications manager 1020 may support wireless communication in accordance with examples as disclosed herein. The coding rate component 1025 may be configured as or otherwise support a means for computing a coding rate associated with each coding level of a coded modulation scheme based on one or more channel conditions of a wireless channel. The bit allocation component 1030 may be configured as or otherwise support a means for allocating a set of multiple information bits among a set of multiple coding schemes associated with a MLC scheme, where a quantity of information bits allocated to each coding scheme is based on the coding rates associated with one or more coding levels corresponding to the coding scheme. The encoding component 1035 may be configured as or otherwise support a means for encoding an information payload using the set of multiple coding schemes in accordance with the allocation of the set of multiple information bits. The communication component 1040 may be configured as or otherwise support a means for transmitting the encoded information payload via the wireless channel.

In some examples, to support computing the coding rate for each coding level, the coding rate component 1025 may be configured as or otherwise support a means for computing a set of coding rates associated with a set of modulation bits of the coded modulation scheme, each coding level of the coded modulation scheme corresponding to one or more modulation bits of the coded modulation scheme, where the coding rate associated with each coding level is a coding rate associated with the one or more modulation bits of each respective coding level.

In some examples, to support computing the set of coding rates, the coding rate component 1025 may be configured as or otherwise support a means for computing a coding rate associated with a modulation bit of the coded modulation scheme based on bit values of modulation bits corresponding to less significant bits than the modulation bit.

In some examples, to support computing the set of coding rates, the coding rate component 1025 may be configured as or otherwise support a means for computing a coding rate associated with a modulation bit of the coded modulation scheme based on excluding bit values of other modulation bits of the coded modulation scheme from the computation of the coding rate associated with the modulation bit.

In some examples, to support computing the set of coding rates, the coding rate component 1025 may be configured as or otherwise support a means for computing the set of coding rates such that a summation of the set of coding rates is equal to a quantity of the coding levels multiplied by a coding rate associated with the wireless channel.

In some examples, the polarization component 1050 may be configured as or otherwise support a means for polarizing the coding levels into a set of polarized coding levels, each polarized coding level associated with a respective second coding rate, where each coding scheme corresponds to one or more polarized coding levels, and where the quantity of information bits allocated to each coding scheme is based on the second coding rates associated with the one or more polarized coding levels corresponding to the coding scheme.

In some examples, the polarization component 1050 may be configured as or otherwise support a means for polarizing a subset of the coding levels into a set of polarized coding levels, each polarized coding level associated with a respective second coding rate, where each coding scheme corresponds to one or more non-polarized coding levels, one or more polarized coding levels, or a combination thereof, and where the quantity of information bits allocated to each coding scheme is based on the coding rates corresponding to the coding scheme, the second coding rates associated with the one or more polarized coding levels corresponding to the coding scheme, or a combination thereof.

In some examples, the coding rate component 1025 may be configured as or otherwise support a means for computing a second coding rate associated with each spatial layer of a set of spatial layers based on the one or more channel conditions of the wireless channel, the set of spatial layers associated with a set of coded modulation schemes including the coded modulation scheme, where each coding scheme corresponds to one or more spatial layers of the set of spatial layers, and where the quantity of information bits allocated to each coding scheme is based on the second coding rates associated with the one or more spatial layers corresponding to the coding scheme.

In some examples, the quantity of information bits allocated to each coding scheme is proportional to the coding rates corresponding to the coding scheme.

In some examples, the quantity of information bits allocated to each coding scheme is based on a ratio of a summation of the coding rates corresponding to the coding scheme to a summation of each of the coding rates.

In some examples, a quantity of coding schemes of the set of multiple coding schemes is less than or equal to a quantity of coding levels of the coded modulation scheme.

In some examples, the bit allocation component 1030 may be configured as or otherwise support a means for allocating a set of multiple non-information bits among the set of multiple coding schemes, where a quantity of non-information bits allocated to each coding scheme is based on the coding rates associated with the one or more coding levels corresponding to the coding scheme, and where the information payload is encoded in accordance with the allocation of the set of multiple non-information bits.

In some examples, a coding scheme of the set of multiple the coding schemes is an unencoded coding scheme based on a coding rate corresponding to the coding scheme satisfying a threshold.

In some examples, the one or more channel conditions include a capacity of the wireless channel, a coding rate associated with the wireless channel, a reliability of the wireless channel or a combination thereof.

In some examples, the set of multiple coding schemes includes one or more LDPC codes, one or more turbo codes, one or more polar codes, one or more Reed Solomon codes, one or more staircase codes, one or more rateless codes, one or more product codes, one or more spinal codes, one or more Reed Muller codes, one or more BCH codes, or any combination thereof.

In some examples, the set of multiple coding schemes includes a set of multiple polar codes.

In some examples, the set of multiple coding schemes includes a joint polar code including a set of multiple subpolar codes. In some examples, each subpolar code corresponds to one or more coding levels of the coded modulation scheme.

Additionally, or alternatively, the communications manager 1020 may support wireless communication in accordance with examples as disclosed herein. In some examples, the communication component 1040 may be configured as or otherwise support a means for receiving an information payload of encoded bits via a wireless channel. In some examples, the coding rate component 1025 may be configured as or otherwise support a means for computing a coding rate associated with each coding level of a coded modulation scheme based on one or more channel conditions of the wireless channel. In some examples, the bit allocation component 1030 may be configured as or otherwise support a means for allocating a set of multiple information bits among a set of multiple coding schemes associated with a MLC scheme, where each coding scheme corresponds to one or more coding levels of the coded modulation scheme, and where a quantity of information bits allocated to each coding scheme is based on the coding rates associated with the one or more coding levels corresponding to the coding scheme. The decoding component 1045 may be configured as or otherwise support a means for decoding the information payload using the set of multiple coding schemes in accordance with the allocation of the set of multiple information bits.

In some examples, to support computing the coding rate for each coding level, the coding rate component 1025 may be configured as or otherwise support a means for computing a set of coding rates associated with a set of modulation bits of the coded modulation scheme, each coding level of the coded modulation scheme corresponding to one or more modulation bits of the coded modulation scheme, where the coding rate associated with each coding level is a coding rate associated with the one or more modulation bits of each respective coding level.

In some examples, to support computing the set of coding rates, the coding rate component 1025 may be configured as or otherwise support a means for computing a coding rate associated with a modulation bit of the coded modulation scheme based on bit values of modulation bits corresponding to less significant bits than the modulation bit.

In some examples, to support computing the set of coding rates, the coding rate component 1025 may be configured as or otherwise support a means for computing a coding rate associated with a modulation bit of the coded modulation scheme based on excluding bit values of other modulation bits of the coded modulation scheme from the computation of the coding rate associated with the modulation bit.

In some examples, to support computing the set of coding rates, the coding rate component 1025 may be configured as or otherwise support a means for computing the set of coding rates such that a summation of the set of coding rates is equal to a quantity of the coding levels multiplied by a coding rate associated with the wireless channel.

In some examples, the polarization component 1050 may be configured as or otherwise support a means for polarizing the coding levels into a set of polarized coding levels, each polarized coding level associated with a respective second coding rate, where each coding scheme corresponds to one or more polarized coding levels, and where the quantity of information bits allocated to each coding scheme is based on the second coding rates associated with the one or more polarized coding levels corresponding to the coding scheme.

In some examples, the polarization component 1050 may be configured as or otherwise support a means for polarizing a subset of the coding levels into a set of polarized coding levels, each polarized coding level associated with a respective second coding rate, where each coding scheme corresponds to one or more non-polarized coding levels, one or more polarized coding levels, or a combination thereof, and where the quantity of information bits allocated to each coding scheme is based on the coding rates corresponding to the coding scheme, the second coding rates associated with the one or more polarized coding levels corresponding to the coding scheme, or a combination thereof.

In some examples, the coding rate component 1025 may be configured as or otherwise support a means for computing a second coding rate associated with each spatial layer of a set of spatial layers based on the one or more channel conditions of the wireless channel, the set of spatial layers associated with a set of coded modulation schemes including the coded modulation scheme, where each coding scheme corresponds to one or more spatial layers of the set of spatial layers, and where the quantity of information bits allocated to each coding scheme is based on the second coding rates associated with the one or more spatial layers corresponding to the coding scheme.

In some examples, the quantity of information bits allocated to each coding scheme is proportional to the coding rates corresponding to the coding scheme.

In some examples, the quantity of information bits allocated to each coding scheme is based on a ratio of a summation of the coding rates corresponding to the coding scheme to a summation of each of the coding rates.

In some examples, a quantity of coding schemes of the set of multiple coding schemes is less than or equal to a quantity of coding levels of the coded modulation scheme.

In some examples, the bit allocation component 1030 may be configured as or otherwise support a means for allocating a set of multiple non-information bits among the set of multiple coding schemes, where a quantity of non-information bits allocated to each coding scheme is based on the coding rates associated with the one or more coding levels corresponding to the coding scheme, and where the information payload is decoded in accordance with the allocation of the set of multiple non-information bits.

In some examples, a coding scheme of the set of multiple the coding schemes is an unencoded coding scheme based on a coding rate corresponding to the coding scheme satisfying a threshold.

In some examples, the one or more channel conditions include a capacity of the wireless channel, a coding rate associated with the wireless channel, a reliability of the wireless channel or a combination thereof.

In some examples, the set of multiple coding schemes includes one or more low-density parity check codes, one or more turbo codes, one or more polar codes, one or more Reed Solomon codes, one or more staircase codes, one or more rateless codes, one or more product codes, one or more spinal codes, one or more Reed Muller codes, one or more Bose-Chaudhuri-Hocquenghem codes, or any combination thereof.

In some examples, the set of multiple coding schemes includes a set of multiple polar codes.

In some examples, the set of multiple coding schemes includes a joint polar code including a set of multiple subpolar codes. In some examples, each subpolar code corresponds to one or more coding levels of the coded modulation scheme.

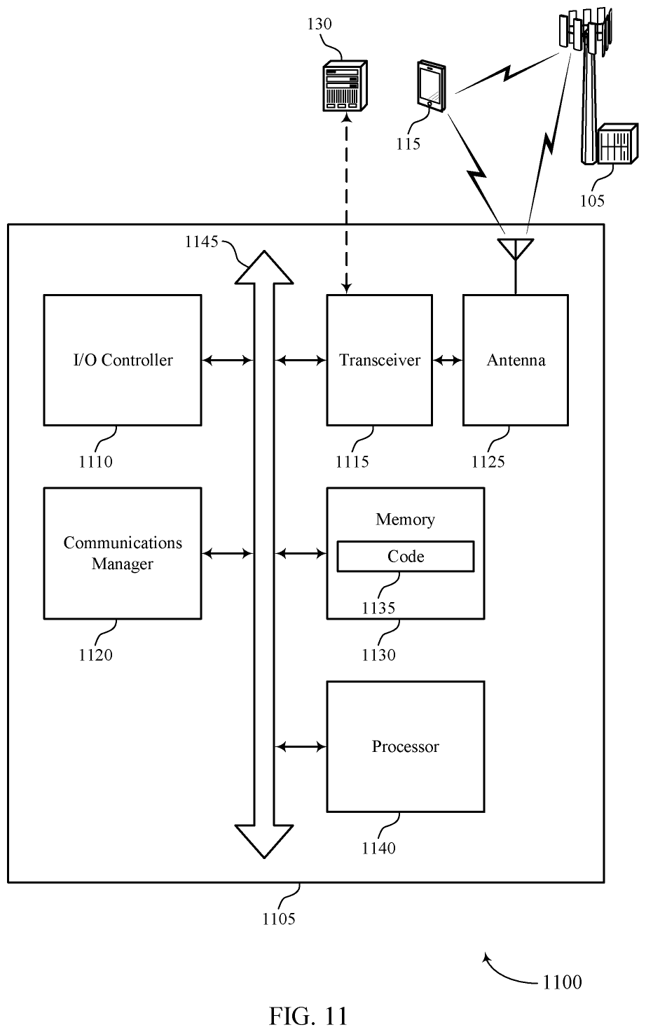

FIG. 11 shows a diagram of a system 1100 including a device 1105 that supports bit allocations for MLC in wireless communications in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein. The transceiver 1510, or the transceiver 1510 and one or more antennas 1515 or wired interfaces, where applicable, may be an example of a transmitter 1215, a transmitter 1315, a receiver 1210, a receiver 1310, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting bit allocations for MLC in wireless communications). For example, the device 1105 or a component of the device 1105 may include a processor 1140 and memory 1130 coupled with or to the processor 1140, the processor 1140 and memory 1130 configured to perform various functions described herein.

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with network nodes 105, and may include a controller or scheduler for controlling communications with UEs 115 in cooperation with other network nodes 105. In some examples, the communications manager 1120 may support an X2 interface within an LTE/LTE-A wireless communications network technology to provide communication between network nodes 105.

The communications manager 1120 may support wireless communication in accordance with examples as disclosed herein. For example, the communications manager 1120 may be configured as or otherwise support a means for computing a coding rate associated with each coding level of a coded modulation scheme based on one or more channel conditions of a wireless channel. The communications manager 1120 may be configured as or otherwise support a means for allocating a set of multiple information bits among a set of multiple coding schemes associated with a MLC scheme, where a quantity of information bits allocated to each coding scheme is based on the coding rates associated with one or more coding levels corresponding to the coding scheme. The communications manager 1120 may be configured as or otherwise support a means for encoding an information payload using the set of multiple coding schemes in accordance with the allocation of the set of multiple information bits. The communications manager 1120 may be configured as or otherwise support a means for transmitting the encoded information payload via the wireless channel.

Additionally, or alternatively, the communications manager 1120 may support wireless communication in accordance with examples as disclosed herein. For example, the communications manager 1120 may be configured as or otherwise support a means for receiving an information payload of encoded bits via a wireless channel. The communications manager 1120 may be configured as or otherwise support a means for computing a coding rate associated with each coding level of a coded modulation scheme based on one or more channel conditions of the wireless channel. The communications manager 1120 may be configured as or otherwise support a means for allocating a set of multiple information bits among a set of multiple coding schemes associated with a MLC scheme, where each coding scheme corresponds to one or more coding levels of the coded modulation scheme, and where a quantity of information bits allocated to each coding scheme is based on the coding rates associated with the one or more coding levels corresponding to the coding scheme. The communications manager 1120 may be configured as or otherwise support a means for decoding the information payload using the set of multiple coding schemes in accordance with the allocation of the set of multiple information bits.

By including or configuring the communications manager 1120 in accordance with examples as described herein, the device 1105 may support techniques for enabling the device 1105 to support a MLC scheme in a wireless communications channel. For example, the device 1105 may utilize the MLC scheme to improve communication reliability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of bit allocations for MLC in wireless communications as described herein, or the processor 1140 and the memory 1130 may be otherwise configured to perform or support such operations.

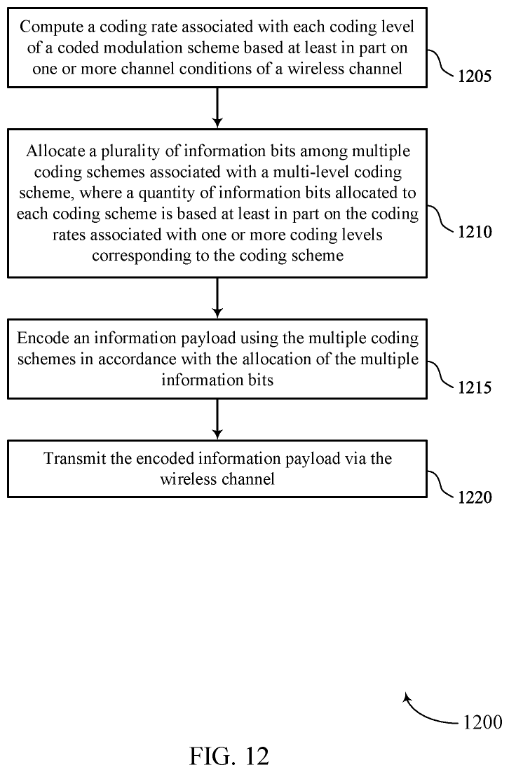

FIG. 12 shows a flowchart illustrating a method 1200 that supports bit allocations for MLC in wireless communications in accordance with one or more aspects of the present disclosure. The operations of the method 1200 may be implemented by a UE or its components as described herein. For example, the operations of the method 1200 may be performed by a UE 115, a network entity 105, or a device 205 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include computing a coding rate associated with each coding level of a coded modulation scheme based on one or more channel conditions of a wireless channel. The operations of 1205 may be performed in accordance with examples as disclosed herein. In some examples, aspects of the operations of 1205 may be performed by a coding rate component 1025 as described with reference to FIG. 10.

At 1210, the method may include allocating a set of multiple information bits among a set of multiple coding schemes associated with a MLC scheme, where a quantity of information bits allocated to each coding scheme is based on the coding rates associated with one or more coding levels corresponding to the coding scheme. The operations of 1210 may be performed in accordance with examples as disclosed herein. In some examples, aspects of the operations of 1210 may be performed by a bit allocation component 1030 as described with reference to FIG. 10.

At 1215, the method may include encoding an information payload using the set of multiple coding schemes in accordance with the allocation of the set of multiple information bits. The operations of 1215 may be performed in accordance with examples as disclosed herein. In some examples, aspects of the operations of 1215 may be performed by an encoding component 1035 as described with reference to FIG. 10.

At 1220, the method may include transmitting the encoded information payload via the wireless channel. The operations of 1220 may be performed in accordance with examples as disclosed herein. In some examples, aspects of the operations of 1220 may be performed by a communication component 1040 as described with reference to FIG. 10.

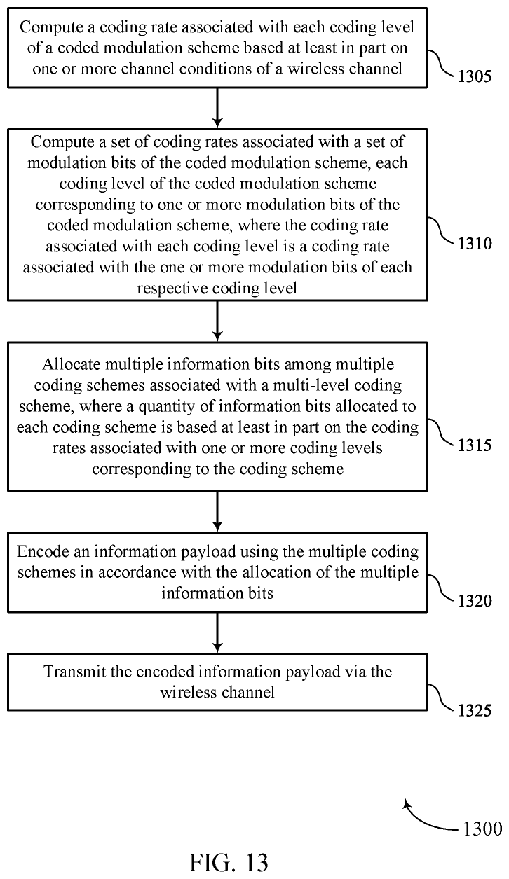

FIG. 13 shows a flowchart illustrating a method 1300 that supports bit allocations for MLC in wireless communications in accordance with one or more aspects of the present disclosure. The operations of the method 1300 may be implemented by a UE or its components as described herein. For example, the operations of the method 1300 may be performed by a UE 115, a network entity 105, or a device 205 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include computing a coding rate associated with each coding level of a coded modulation scheme based on one or more channel conditions of a wireless channel. The operations of 1305 may be performed in accordance with examples as disclosed herein. In some examples, aspects of the operations of 1305 may be performed by a coding rate component 1025 as described with reference to FIG. 10.

At 1310, to support computing the coding rate associated with each coding level, the method may include computing a set of coding rates associated with a set of modulation bits of the coded modulation scheme, each coding level of the coded modulation scheme corresponding to one or more modulation bits of the coded modulation scheme, where the coding rate associated with each coding level is a coding rate associated with the one or more modulation bits of each respective coding level. The operations of 1310 may be performed in accordance with examples as disclosed herein. In some examples, aspects of the operations of 1310 may be performed by a coding rate component 1025 as described with reference to FIG. 10.

At 1315, the method may include allocating a set of multiple information bits among a set of multiple coding schemes associated with a MLC scheme, where a quantity of information bits allocated to each coding scheme is based on the coding rates associated with one or more coding levels corresponding to the coding scheme. The operations of 1315 may be performed in accordance with examples as disclosed herein. In some examples, aspects of the operations of 1315 may be performed by a bit allocation component 1030 as described with reference to FIG. 10.

At 1320, the method may include encoding an information payload using the set of multiple coding schemes in accordance with the allocation of the set of multiple information bits. The operations of 1320 may be performed in accordance with examples as disclosed herein. In some examples, aspects of the operations of 1320 may be performed by an encoding component 1035 as described with reference to FIG. 10.

At 1325, the method may include transmitting the encoded information payload via the wireless channel. The operations of 1325 may be performed in accordance with examples as disclosed herein. In some examples, aspects of the operations of 1325 may be performed by a communication component 1040 as described with reference to FIG. 10.

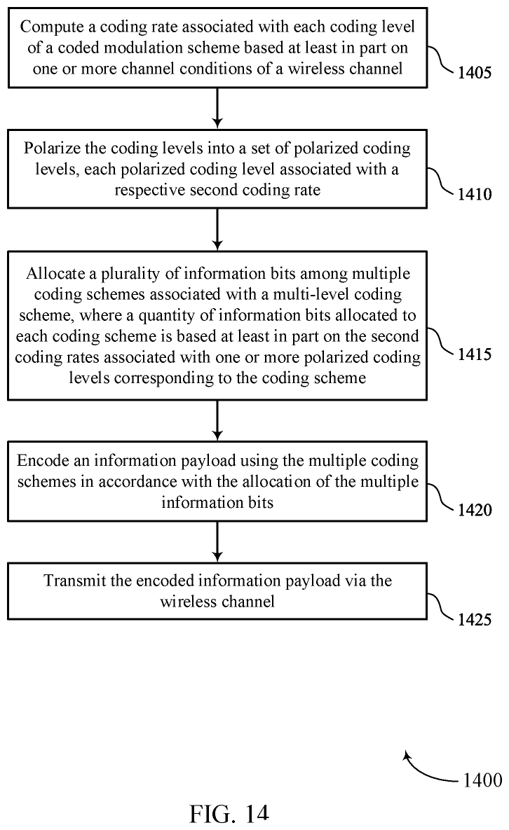

FIG. 14 shows a flowchart illustrating a method 1400 that supports bit allocations for MLC in wireless communications in accordance with one or more aspects of the present disclosure. The operations of the method 1400 may be implemented by a UE or its components as described herein. For example, the operations of the method 1400 may be performed by a UE 115, a network entity 105, or a device 205 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include computing a coding rate associated with each coding level of a coded modulation scheme based on one or more channel conditions of a wireless channel. The operations of 1405 may be performed in accordance with examples as disclosed herein. In some examples, aspects of the operations of 1405 may be performed by a coding rate component 1025 as described with reference to FIG. 10.

At 1410, the method may include polarizing the coding levels into a set of polarized coding levels, each polarized coding level associated with a respective second coding rate. The operations of 1410 may be performed in accordance with examples as disclosed herein. In some examples, aspects of the operations of 1410 may be performed by a polarization component 1050 as described with reference to FIG. 10.

At 1415, the method may include allocating a set of multiple information bits among a set of multiple coding schemes associated with a MLC scheme, where a quantity of information bits allocated to each coding scheme is based on the second coding rates associated with one or more polarized coding levels corresponding to the coding scheme. The operations of 1415 may be performed in accordance with examples as disclosed herein. In some examples, aspects of the operations of 1415 may be performed by a bit allocation component 1030 as described with reference to FIG. 10.

At 1420, the method may include encoding an information payload using the set of multiple coding schemes in accordance with the allocation of the set of multiple information bits. The operations of 1420 may be performed in accordance with examples as disclosed herein. In some examples, aspects of the operations of 1420 may be performed by an encoding component 1035 as described with reference to FIG. 10.

At 1425, the method may include transmitting the encoded information payload via the wireless channel. The operations of 1425 may be performed in accordance with examples as disclosed herein. In some examples, aspects of the operations of 1425 may be performed by a communication component 1040 as described with reference to FIG. 10.

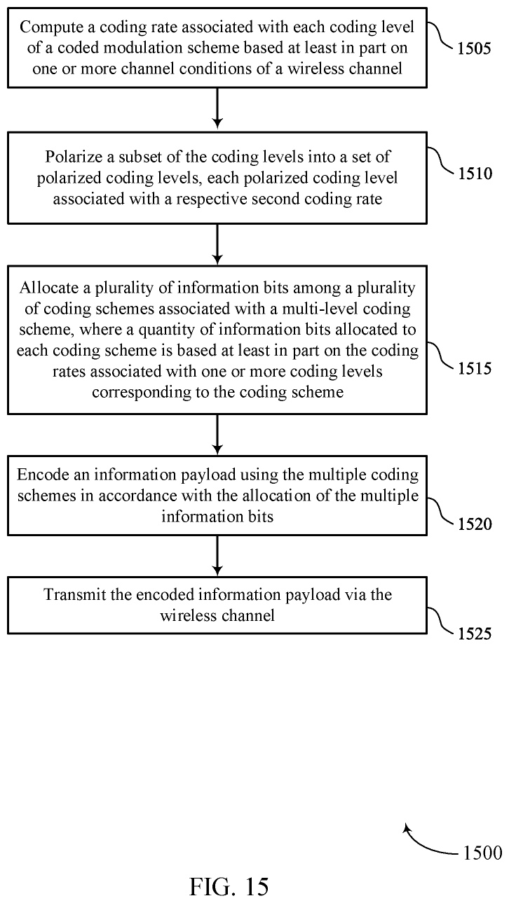

FIG. 15 shows a flowchart illustrating a method 1500 that supports bit allocations for MLC in wireless communications in accordance with one or more aspects of the present disclosure. The operations of the method 1500 may be implemented by a UE or its components as described herein. For example, the operations of the method 1500 may be performed by a UE 115, a network entity 105, or a device 205 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include computing a coding rate associated with each coding level of a coded modulation scheme based on one or more channel conditions of a wireless channel. The operations of 1505 may be performed in accordance with examples as disclosed herein. In some examples, aspects of the operations of 1505 may be performed by a coding rate component 1025 as described with reference to FIG. 10.

At 1510, the method may include polarizing a subset of the coding levels into a set of polarized coding levels, each polarized coding level associated with a respective second coding rate. The operations of 1510 may be performed in accordance with examples as disclosed herein. In some examples, aspects of the operations of 1510 may be performed by a polarization component 1050 as described with reference to FIG. 10.

At 1515, the method may include allocating a set of multiple information bits among a set of multiple coding schemes associated with a MLC scheme, where a quantity of information bits allocated to each coding scheme is based on the coding rates associated with one or more coding levels corresponding to the coding scheme. The operations of 1515 may be performed in accordance with examples as disclosed herein. In some examples, aspects of the operations of 1515 may be performed by a bit allocation component 1030 as described with reference to FIG. 10.

At 1520, the method may include encoding an information payload using the set of multiple coding schemes in accordance with the allocation of the set of multiple information bits. The operations of 1520 may be performed in accordance with examples as disclosed herein. In some examples, aspects of the operations of 1520 may be performed by an encoding component 1035 as described with reference to FIG. 10.

At 1525, the method may include transmitting the encoded information payload via the wireless channel. The operations of 1525 may be performed in accordance with examples as disclosed herein. In some examples, aspects of the operations of 1525 may be performed by a communication component 1040 as described with reference to FIG. 10.

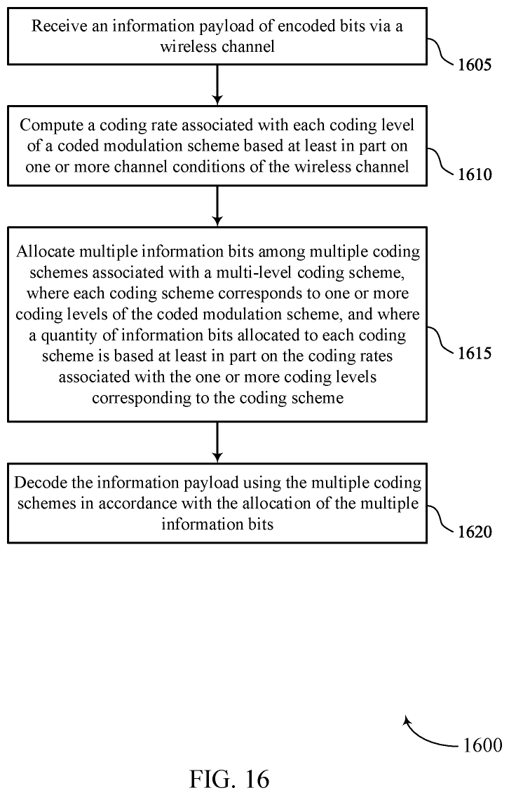

FIG. 16 shows a flowchart illustrating a method 1600 that supports bit allocations for MLC in wireless communications in accordance with one or more aspects of the present disclosure. The operations of the method 1600 may be implemented by a UE, a network entity, a decoding device, or an encoding device or corresponding components as described herein. For example, the operations of the method 1600 may be performed by a UE 115, a network entity 105, or a device 205 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving an information payload of encoded bits via a wireless channel. The operations of 1605 may be performed in accordance with examples as disclosed herein. In some examples, aspects of the operations of 1605 may be performed by a communication component 1040 as described with reference to FIG. 10.

At 1610, the method may include computing a coding rate associated with each coding level of a coded modulation scheme based on one or more channel conditions of the wireless channel. The operations of 1610 may be performed in accordance with examples as disclosed herein. In some examples, aspects of the operations of 1610 may be performed by a coding rate component 1025 as described with reference to FIG. 10.

At 1615, the method may include allocating a set of multiple information bits among a set of multiple coding schemes associated with a MLC scheme, where each coding scheme corresponds to one or more coding levels of the coded modulation scheme, and where a quantity of information bits allocated to each coding scheme is based on the coding rates associated with the one or more coding levels corresponding to the coding scheme. The operations of 1615 may be performed in accordance with examples as disclosed herein. In some examples, aspects of the operations of 1615 may be performed by a bit allocation component 1030 as described with reference to FIG. 10.

At 1620, the method may include decoding the information payload using the set of multiple coding schemes in accordance with the allocation of the set of multiple information bits. The operations of 1620 may be performed in accordance with examples as disclosed herein. In some examples, aspects of the operations of 1620 may be performed by a decoding component 1045 as described with reference to FIG. 10.

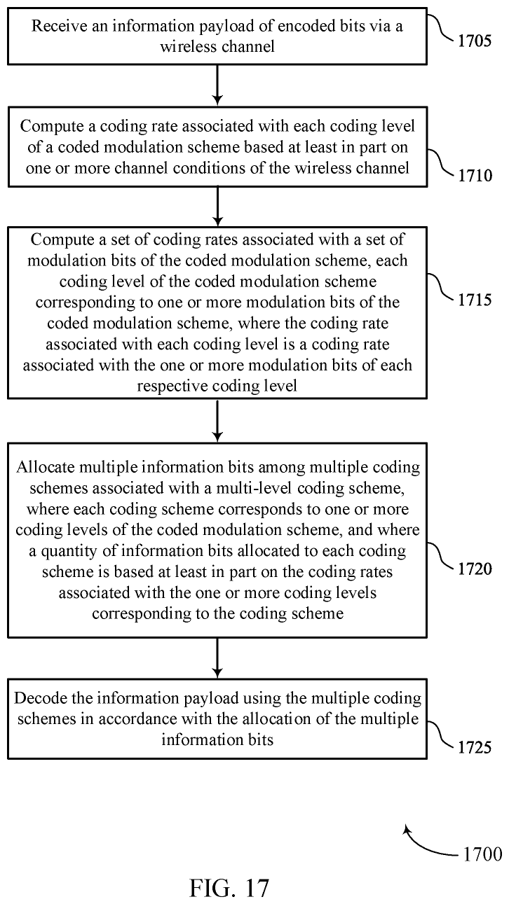

FIG. 17 shows a flowchart illustrating a method 1700 that supports bit allocations for MLC in wireless communications in accordance with one or more aspects of the present disclosure. The operations of the method 1700 may be implemented by a UE or its components as described herein. For example, the operations of the method 1700 may be performed by a UE 115, a network entity 105, or a device 205 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving an information payload of encoded bits via a wireless channel. The operations of 1705 may be performed in accordance with examples as disclosed herein. In some examples, aspects of the operations of 1705 may be performed by a communication component 1040 as described with reference to FIG. 10.

At 1710, the method may include computing a coding rate associated with each coding level of a coded modulation scheme based on one or more channel conditions of the wireless channel. The operations of 1710 may be performed in accordance with examples as disclosed herein. In some examples, aspects of the operations of 1710 may be performed by a coding rate component 1025 as described with reference to FIG. 10.

At 1715, the method may include computing a set of coding rates associated with a set of modulation bits of the coded modulation scheme, each coding level of the coded modulation scheme corresponding to one or more modulation bits of the coded modulation scheme, where the coding rate associated with each coding level is a coding rate associated with the one or more modulation bits of each respective coding level. The operations of 1715 may be performed in accordance with examples as disclosed herein. In some examples, aspects of the operations of 1715 may be performed by a coding rate component 1025 as described with reference to FIG. 10.

At 1720, the method may include allocating a set of multiple information bits among a set of multiple coding schemes associated with a MLC scheme, where each coding scheme corresponds to one or more coding levels of the coded modulation scheme, and where a quantity of information bits allocated to each coding scheme is based on the coding rates associated with the one or more coding levels corresponding to the coding scheme. The operations of 1720 may be performed in accordance with examples as disclosed herein. In some examples, aspects of the operations of 1720 may be performed by a bit allocation component 1030 as described with reference to FIG. 10.

At 1725, the method may include decoding the information payload using the set of multiple coding schemes in accordance with the allocation of the set of multiple information bits. The operations of 1725 may be performed in accordance with examples as disclosed herein. In some examples, aspects of the operations of 1725 may be performed by a decoding component 1045 as described with reference to FIG. 10.

The following provides an overview of aspects of the present disclosure:

Aspect 1: A method for wireless communication, comprising: computing a coding rate associated with each coding level of a coded modulation scheme based at least in part on one or more channel conditions of a wireless channel; allocating a plurality of information bits among a plurality of coding schemes associated with a MLC scheme, wherein a quantity of information bits allocated to each coding scheme is based at least in part on the coding rates associated with one or more coding levels corresponding to the coding scheme; encoding an information payload using the plurality of coding schemes in accordance with the allocation of the plurality of information bits; and transmitting the encoded information payload via the wireless channel.

Aspect 2: The method of aspect 1, wherein computing the coding rate for each coding level comprises: computing a set of coding rates associated with a set of modulation bits of the coded modulation scheme, each coding level of the coded modulation scheme corresponding to one or more modulation bits of the coded modulation scheme, wherein the coding rate associated with each coding level is a coding rate associated with the one or more modulation bits of each respective coding level.

Aspect 3: The method of aspect 2, wherein computing the set of coding rates comprises: computing a coding rate associated with a modulation bit of the coded modulation scheme based at least in part on bit values of modulation bits corresponding to less significant bits than the modulation bit.

Aspect 4: The method of aspect 2, wherein computing the set of coding rates comprises: computing a coding rate associated with a modulation bit of the coded modulation scheme based at least in part on excluding bit values of other modulation bits of the coded modulation scheme from the computation of the coding rate associated with the modulation bit.

Aspect 5: The method of any of aspects 2 through 4, wherein computing the set of coding rates comprises: computing the set of coding rates such that a summation of the set of coding rates is equal to a quantity of the coding levels multiplied by a coding rate associated with the wireless channel.

Aspect 6: The method of any of aspects 1 through 5, further comprising: polarizing the coding levels into a set of polarized coding levels, each polarized coding level associated with a respective second coding rate, wherein each coding scheme corresponds to one or more polarized coding levels, and wherein the quantity of information bits allocated to each coding scheme is based at least in part on the second coding rates associated with the one or more polarized coding levels corresponding to the coding scheme.

Aspect 7: The method of any of aspects 1 through 5, further comprising: polarizing a subset of the coding levels into a set of polarized coding levels, each polarized coding level associated with a respective second coding rate, wherein each coding scheme corresponds to one or more non-polarized coding levels, one or more polarized coding levels, or a combination thereof, and wherein the quantity of information bits allocated to each coding scheme is based at least in part on the coding rates corresponding to the coding scheme, the second coding rates associated with the one or more polarized coding levels corresponding to the coding scheme, or a combination thereof.

Aspect 8: The method of any of aspects 1 through 7, further comprising: computing a second coding rate associated with each spatial layer of a set of spatial layers based at least in part on the one or more channel conditions of the wireless channel, the set of spatial layers associated with a set of coded modulation schemes comprising the coded modulation scheme, wherein each coding scheme corresponds to one or more spatial layers of the set of spatial layers, and wherein the quantity of information bits allocated to each coding scheme is based at least in part on the second coding rates associated with the one or more spatial layers corresponding to the coding scheme.

Aspect 9: The method of any of aspects 1 through 8, wherein the quantity of information bits allocated to each coding scheme is proportional to the coding rates corresponding to the coding scheme.

Aspect 10: The method of any of aspects 1 through 9, wherein the quantity of information bits allocated to each coding scheme is based at least in part on a ratio of a summation of the coding rates corresponding to the coding scheme to a summation of each of the coding rates.

Aspect 11: The method of any of aspects 1 through 10, wherein a quantity of coding schemes of the plurality of coding schemes is less than or equal to a quantity of coding levels of the coded modulation scheme.

Aspect 12: The method of any of aspects 1 through 11, further comprising: allocating a plurality of non-information bits among the plurality of coding schemes, wherein a quantity of non-information bits allocated to each coding scheme is based at least in part on the coding rates associated with the one or more coding levels corresponding to the coding scheme, and wherein the information payload is encoded in accordance with the allocation of the plurality of non-information bits.

Aspect 13: The method of any of aspects 1 through 12, wherein a coding scheme of the plurality of the coding schemes is an unencoded coding scheme based at least in part on a coding rate corresponding to the coding scheme satisfying a threshold.

Aspect 14: The method of any of aspects 1 through 13, wherein the one or more channel conditions comprise a capacity of the wireless channel, a coding rate associated with the wireless channel, a reliability of the wireless channel or a combination thereof.

Aspect 15: The method of any of aspects 1 through 14, wherein the plurality of coding schemes comprises one or more LDPC codes, one or more turbo codes, one or more polar codes, one or more Reed Solomon codes, one or more staircase codes, one or more rateless codes, one or more product codes, one or more spinal codes, one or more Reed Muller codes, one or more BCH codes, or any combination thereof.

Aspect 16: The method of any of aspects 1 through 15, wherein the plurality of coding schemes comprises a plurality of polar codes.

Aspect 17: The method of any of aspects 1 through 14, wherein the plurality of coding schemes comprises a joint polar code comprising a plurality of subpolar codes, and each subpolar code corresponds to one or more coding levels of the coded modulation scheme.

Aspect 18: A method for wireless communication, comprising: receiving an information payload of encoded bits via a wireless channel; computing a coding rate associated with each coding level of a coded modulation scheme based at least in part on one or more channel conditions of the wireless channel; allocating a plurality of information bits among a plurality of coding schemes associated with a MLC scheme, wherein a quantity of information bits allocated to each coding scheme is based at least in part on the coding rates associated with one or more coding levels corresponding to the coding scheme; and decoding the information payload using the plurality of coding schemes in accordance with the allocation of the plurality of information bits.

Aspect 19: The method of aspect 18, wherein computing the coding rate for each coding level comprises: computing a set of coding rates associated with a set of modulation bits of the coded modulation scheme, each coding level of the coded modulation scheme corresponding to one or more modulation bits of the coded modulation scheme, wherein the coding rate associated with each coding level is a coding rate associated with the one or more modulation bits of each respective coding level.

Aspect 20: The method of aspect 19, wherein computing the set of coding rates comprises: computing a coding rate associated with a modulation bit of the coded modulation scheme based at least in part on bit values of modulation bits corresponding to less significant bits than the modulation bit.

Aspect 21: The method of aspect 19, wherein computing the set of coding rates comprises: computing a coding rate associated with a modulation bit of the coded modulation scheme based at least in part on excluding bit values of other modulation bits of the coded modulation scheme from the computation of the coding rate associated with the modulation bit.

Aspect 22: The method of any of aspects 19 through 21, wherein computing the set of coding rates comprises: computing the set of coding rates such that a summation of the set of coding rates is equal to a quantity of the coding levels multiplied by a coding rate associated with the wireless channel.

Aspect 23: The method of any of aspects 18 through 22, further comprising: polarizing the coding levels into a set of polarized coding levels, each polarized coding level associated with a respective second coding rate, wherein each coding scheme corresponds to one or more polarized coding levels, and wherein the quantity of information bits allocated to each coding scheme is based at least in part on the second coding rates associated with the one or more polarized coding levels corresponding to the coding scheme.

Aspect 24: The method of any of aspects 18 through 22, further comprising: polarizing a subset of the coding levels into a set of polarized coding levels, each polarized coding level associated with a respective second coding rate, wherein each coding scheme corresponds to one or more non-polarized coding levels, one or more polarized coding levels, or a combination thereof, and wherein the quantity of information bits allocated to each coding scheme is based at least in part on the coding rates corresponding to the coding scheme, the second coding rates associated with the one or more polarized coding levels corresponding to the coding scheme, or a combination thereof.

Aspect 25: The method of any of aspects 18 through 24, further comprising: computing a second coding rate associated with each spatial layer of a set of spatial layers based at least in part on the one or more channel conditions of the wireless channel, the set of spatial layers associated with a set of coded modulation schemes comprising the coded modulation scheme, wherein each coding scheme corresponds to one or more spatial layers of the set of spatial layers, and wherein the quantity of information bits allocated to each coding scheme is based at least in part on the second coding rates associated with the one or more spatial layers corresponding to the coding scheme.

Aspect 26: The method of any of aspects 18 through 25, wherein the quantity of information bits allocated to each coding scheme is proportional to the coding rates corresponding to the coding scheme.

Aspect 27: The method of any of aspects 18 through 26, wherein the quantity of information bits allocated to each coding scheme is based at least in part on a ratio of a summation of the coding rates corresponding to the coding scheme to a summation of each of the coding rates.

Aspect 28: The method of any of aspects 18 through 27, wherein a quantity of coding schemes of the plurality of coding schemes is less than or equal to a quantity of coding levels of the coded modulation scheme.

Aspect 29: The method of any of aspects 18 through 28, further comprising: allocating a plurality of non-information bits among the plurality of coding schemes, wherein a quantity of non-information bits allocated to each coding scheme is based at least in part on the coding rates associated with the one or more coding levels corresponding to the coding scheme, and wherein the information payload is decoded in accordance with the allocation of the plurality of non-information bits.

Aspect 30: The method of any of aspects 18 through 29, wherein a coding scheme of the plurality of the coding schemes is an unencoded coding scheme based at least in part on a coding rate corresponding to the coding scheme satisfying a threshold.

Aspect 31: The method of any of aspects 18 through 30, wherein the one or more channel conditions comprise a capacity of the wireless channel, a coding rate associated with the wireless channel, a reliability of the wireless channel or a combination thereof.

Aspect 32: The method of any of aspects 18 through 31, wherein the plurality of coding schemes comprises one or more LDPC codes, one or more turbo codes, one or more polar codes, one or more Reed Solomon codes, one or more staircase codes, one or more rateless codes, one or more product codes, one or more spinal codes, one or more Reed Muller codes, one or more BCH codes, or any combination thereof.

Aspect 33: The method of any of aspects 18 through 32, wherein the plurality of coding schemes comprises a plurality of polar codes.

Aspect 34: The method of any of aspects 18 through 31, wherein the plurality of coding schemes comprises a joint polar code comprising a plurality of subpolar codes, and each subpolar code corresponds to one or more coding levels of the coded modulation scheme.

Aspect 35: An apparatus for wireless communication, comprising a processor; memory coupled with the processor; and instructions stored in the memory and executable by the processor to cause the apparatus to perform a method of any of aspects 1 through 17.

Aspect 36: An apparatus for wireless communication, comprising at least one means for performing a method of any of aspects 1 through 17.

Aspect 37: A non-transitory computer-readable medium storing code for wireless communication, the code comprising instructions executable by a processor to perform a method of any of aspects 1 through 17.

Aspect 38: An apparatus for wireless communication, comprising a processor; memory coupled with the processor; and instructions stored in the memory and executable by the processor to cause the apparatus to perform a method of any of aspects 18 through 34.

Aspect 39: An apparatus for wireless communication, comprising at least one means for performing a method of any of aspects 18 through 34.

Aspect 40: A non-transitory computer-readable medium storing code for wireless communication, the code comprising instructions executable by a processor to perform a method of any of aspects 18 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
a processor;
memory coupled with the processor; and
instructions stored in the memory and executable by the processor to cause the apparatus to:
compute a coding rate associated with each coding level of a coded modulation scheme based at least in part on one or more channel conditions of a wireless channel;
allocate a plurality of information bits among a plurality of coding schemes associated with a multi-level coding scheme, wherein a quantity of information bits allocated to each coding scheme is based at least in part on the coding rates associated with one or more coding levels corresponding to the coding scheme;
encode an information payload using the plurality of coding schemes in accordance with the allocation of the plurality of information bits; and
transmit the encoded information payload via the wireless channel.

2. The apparatus of claim 1, wherein the instructions to compute the coding rate for each coding level are executable by the processor to cause the apparatus to:
compute a set of coding rates associated with a set of modulation bits of the coded modulation scheme, each coding level of the coded modulation scheme corresponding to one or more modulation bits of the coded modulation scheme,
wherein the coding rate associated with each coding level is a coding rate associated with the one or more modulation bits of each respective coding level.

3. The apparatus of claim 2, wherein the instructions to compute the set of coding rates are executable by the processor to cause the apparatus to:
compute a coding rate associated with a modulation bit of the coded modulation scheme based at least in part on bit values of modulation bits corresponding to less significant bits than the modulation bit.

4. The apparatus of claim 2, wherein the instructions to compute the set of coding rates are executable by the processor to cause the apparatus to:
compute a coding rate associated with a modulation bit of the coded modulation scheme based at least in part on excluding bit values of other modulation bits of the coded modulation scheme from the computation of the coding rate associated with the modulation bit.

5. The apparatus of claim 2, wherein the instructions to compute the set of coding rates are executable by the processor to cause the apparatus to:
compute the set of coding rates such that a summation of the set of coding rates is equal to a quantity of the coding levels multiplied by a coding rate associated with the wireless channel.

6. The apparatus of claim 1, wherein the instructions are further executable by the processor to cause the apparatus to:
polarize the coding levels into a set of polarized coding levels, each polarized coding level associated with a respective second coding rate, wherein each coding scheme corresponds to one or more polarized coding levels, and
wherein the quantity of information bits allocate to each coding scheme is based at least in part on the second coding rates associated with the one or more polarized coding levels corresponding to the coding scheme.

7. The apparatus of claim 1, wherein the instructions are further executable by the processor to cause the apparatus to:
polarize a subset of the coding levels into a set of polarized coding levels, each polarized coding level associated with a respective second coding rate, wherein each coding scheme corresponds to one or more non-polarized coding levels, one or more polarized coding levels, or a combination thereof, and
wherein the quantity of information bits allocate to each coding scheme is based at least in part on the coding rates corresponding to the coding scheme, the second coding rates associated with the one or more polarized coding levels corresponding to the coding scheme, or a combination thereof.

8. The apparatus of claim 1, wherein the instructions are further executable by the processor to cause the apparatus to:
compute a second coding rate associated with each spatial layer of a set of spatial layers based at least in part on the one or more channel conditions of the wireless channel, the set of spatial layers associated with a set of coded modulation schemes comprising the coded modulation scheme,
wherein each code scheme corresponds to one or more spatial layers of the set of spatial layers, and wherein the quantity of information bits allocated to each coding scheme is based at least in part on the second coding rates associated with the one or more spatial layers corresponding to the coding scheme.

9. The apparatus of claim 1, wherein the quantity of information bits allocated to each coding scheme is proportional to the coding rates corresponding to the coding scheme.

10. The apparatus of claim 1, wherein the quantity of information bits allocated to each coding scheme is based at least in part on a ratio of a summation of the coding rates corresponding to the coding scheme to a summation of each of the coding rates.

11. The apparatus of claim 1, wherein a quantity of coding schemes of the plurality of coding schemes is less than or equal to a quantity of coding levels of the coded modulation scheme.

12. The apparatus of claim 1, wherein the instructions are further executable by the processor to cause the apparatus to:
allocate a plurality of non-information bits among the plurality of coding schemes, wherein a quantity of non-information bits allocated to each coding scheme is based at least in part on the coding rates associated with the one or more coding levels corresponding to the coding scheme, and wherein the information payload is encoded in accordance with the allocation of the plurality of non-information bits.

13. The apparatus of claim 1, wherein a coding scheme of the plurality of the coding schemes is an unencoded coding scheme based at least in part on a coding rate corresponding to the coding scheme satisfying a threshold.

14. The apparatus of claim 1, wherein the one or more channel conditions comprise a capacity of the wireless channel, a coding rate associated with the wireless channel, a reliability of the wireless channel or a combination thereof.

15. The apparatus of claim 1, wherein the plurality of coding schemes comprises one or more low-density parity check codes, one or more turbo codes, one or more polar codes, one or more Reed Solomon codes, one or more staircase codes, one or more rateless codes, one or more product codes, one or more spinal codes, one or more Reed Muller codes, one or more Bose-Chaudhuri-Hocquenghem codes, or any combination thereof.

16. The apparatus of claim 1, wherein the plurality of coding schemes comprises a plurality of polar codes.

17. The apparatus of claim 1, wherein:
the plurality of coding schemes comprises a joint polar code comprising a plurality of subpolar codes, and
each subpolar code corresponds to one or more coding levels of the coded modulation scheme.

18. An apparatus for wireless communication, comprising:
a processor;
memory coupled with the processor; and
instructions stored in the memory and executable by the processor to cause the apparatus to:
receive an information payload of encoded bits via a wireless channel;
compute a coding rate associated with each coding level of a coded modulation scheme based at least in part on one or more channel conditions of the wireless channel;
allocate a plurality of information bits among a plurality of coding schemes associated with a multi-level coding scheme, wherein a quantity of information bits allocated to each coding scheme is based at least in part on the coding rates associated with one or more coding levels corresponding to the coding scheme; and
decode the information payload using the plurality of coding schemes in accordance with the allocation of the plurality of information bits.

19. The apparatus of claim 18, wherein the instructions to compute the coding rate for each coding level are executable by the processor to cause the apparatus to:
compute a set of coding rates associated with a set of modulation bits of the coded modulation scheme, each coding level of the coded modulation scheme corresponding to one or more modulation bits of the coded modulation scheme,
wherein the coding rate associated with each coding level is a coding rate associated with the one or more modulation bits of each respective coding level.

20. The apparatus of claim 19, wherein the instructions to compute the set of coding rates are executable by the processor to cause the apparatus to:
compute a coding rate associated with a modulation bit of the coded modulation scheme based at least in part on bit values of modulation bits corresponding to less significant bits than the modulation bit.

21. The apparatus of claim 19, wherein the instructions to compute the set of coding rates are executable by the processor to cause the apparatus to:
compute a coding rate associated with a modulation bit of the coded modulation scheme based at least in part on excluding bit values of other modulation bits of the coded modulation scheme from the computation of the coding rate associated with the modulation bit.

22. The apparatus of claim 19, wherein the instructions to compute the set of coding rates are executable by the processor to cause the apparatus to:
compute the set of coding rates such that a summation of the set of coding rates is equal to a quantity of the coding levels multiplied by a coding rate associated with the wireless channel.

23. The apparatus of claim 18, wherein the instructions are further executable by the processor to cause the apparatus to:
polarize the coding levels into a set of polarized coding levels, each polarized coding level associated with a respective second coding rate, wherein each coding scheme corresponds to one or more polarized coding levels, and
wherein the quantity of information bits allocate to each coding scheme is based at least in part on the second coding rates associated with the one or more polarized coding levels corresponding to the coding scheme.

24. The apparatus of claim 18, wherein the instructions are further executable by the processor to cause the apparatus to:
polarize a subset of the coding levels into a set of polarized coding levels, each polarized coding level associated with a respective second coding rate, wherein each coding scheme corresponds to one or more non-polarized coding levels, one or more polarized coding levels, or a combination thereof, and
wherein the quantity of information bits allocate to each coding scheme is based at least in part on the coding rates corresponding to the coding scheme, the second coding rates associated with the one or more polarized coding levels corresponding to the coding scheme, or a combination thereof.

25. The apparatus of claim 18, wherein the instructions are further executable by the processor to cause the apparatus to:
compute a second coding rate associated with each spatial layer of a set of spatial layers based at least in part on the one or more channel conditions of the wireless channel, the set of spatial layers associated with a set of coded modulation schemes comprising the coded modulation scheme,
wherein each code scheme corresponds to one or more spatial layers of the set of spatial layers, and wherein the quantity of information bits allocated to each coding scheme is based at least in part on the second coding rates associated with the one or more spatial layers corresponding to the coding scheme.

26. The apparatus of claim 18, wherein the quantity of information bits allocated to each coding scheme is proportional to the coding rates corresponding to the coding scheme.

27. The apparatus of claim 18, wherein the quantity of information bits allocated to each coding scheme is based at least in part on a ratio of a summation of the coding rates corresponding to the coding scheme to a summation of each of the coding rates.

28. The apparatus of claim 18, wherein:
the plurality of coding schemes comprises a joint polar code comprising a plurality of subpolar codes, and
each subpolar code corresponds to one or more coding levels of the coded modulation scheme.

29. A method for wireless communication, comprising:
computing a coding rate associated with each coding level of a coded modulation scheme based at least in part on one or more channel conditions of a wireless channel;
allocating a plurality of information bits among a plurality of coding schemes associated with a multi-level coding scheme, wherein a quantity of information bits allocated to each coding scheme is based at least in part on the coding rates associated with one or more coding levels corresponding to the coding scheme;
encoding an information payload using the plurality of coding schemes in accordance with the allocation of the plurality of information bits; and
transmitting the encoded information payload via the wireless channel.

30. A method for wireless communication, comprising:
receiving an information payload of encoded bits via a wireless channel;
computing a coding rate associated with each coding level of a coded modulation scheme based at least in part on one or more channel conditions of the wireless channel;
allocating a plurality of information bits among a plurality of coding schemes associated with a multi-level coding scheme, wherein a quantity of information bits allocated to each coding scheme is based at least in part on the coding rates associated with one or more coding levels corresponding to the coding scheme; and
decoding the information payload using the plurality of coding schemes in accordance with the allocation of the plurality of information bits.
